(19) United States
(12) Patent Application Publication
(10) Pub. No.: US 2017/0026540 A1
(43) Pub. Date: Jan. 26, 2017

(54) IMAGE FORMING APPARATUS AND METHOD FOR CONTROLLING THE SAME

(71) Applicant: Sharp Kabushiki Kaisha, Osaka (JP)

(72) Inventors: Norihide NAKADA, Sakai City (JP); Takeshi NAKAMURA, Sakai City (JP)

(21) Appl. No.: 15/287,791

(22) Filed: Oct. 7, 2016

Related U.S. Application Data
(63) Continuation of application No. 12/457,647, filed on Jun. 17, 2009, now abandoned.

(30) Foreign Application Priority Data
Jun. 20, 2008 (JP) 2008-162023

(51) Int. Cl. H04N 1/32; H04N 1/44; H04N 1/00

(52) U.S. Cl. CPC H04N 1/32122; H04N 1/00472; H04N 1/00411; H04N 1/00424; H04N 1/00514; H04N 1/4413; H04N 1/4433; H04N 2201/0094

(57) ABSTRACT

In one embodiment of the invention, an image processing apparatus provided with a display unit that displays an operation screen is provided with a user authentication unit that performs user authentication, an input unit that inputs comment information to the operation screen of the display unit, for each user that has been authenticated by the user authentication unit, and an output unit that outputs, among comment information that has been input by the input unit, comment information of a user that has been authenticated by the user authentication unit.

### BACKGROUND OF THE INVENTION

This application claims priority under 35 U.S.C. §119(a) on Patent Application No. 2008-162023 filed in Japan on Jun. 20, 2008, the entire contents of which are herein incorporated by reference.

The present invention relates to an image processing apparatus provided in an image forming apparatus having a print function, such as a digital copier, printer, facsimile apparatus, or digital multifunction peripheral, or in an image sending apparatus having a send function such as a facsimile apparatus or digital multifunction peripheral, and an image forming apparatus and an image sending apparatus that are provided with such an image processing apparatus.

Recently, image forming apparatuses having a print function, such as a digital copier, printer, facsimile apparatus, or digital multifunction peripheral have been equipped with various functions (for example, such as duplex printing, color printing, reduced/enlarged printing, or a job program registration function of pre-registering a job operation sequence). Also, there are image forming apparatuses provided with a function of authenticating a user.

With this type of image forming apparatus, ordinarily, an image processing apparatus in which a user performs an input operation is provided, and by the user performing an operation to execute a desired function based on display information that is displayed on an operation screen of a display unit, the operated function is executed.

For example, JP 2003-118177A discloses an image forming apparatus in which, when an operator authentication means authenticates an operator using input of a username and a password of the operator from an operating means, a job memory management means combines and registers a plurality of copy conditions, and manages the registered copy conditions such that the registered copy conditions can be called when necessary, and manages registration and calling of the copy conditions on a per-operator basis for operators that have been authenticated by the operator authentication means.

Also, in an image sending apparatus having a send function such as a facsimile apparatus or digital multifunction peripheral, various functions (for example, such as one-touch registration or group registration, in which recipient identification information such as a facsimile number or electronic mail address is pre-registered) are provided. Also, there are image sending apparatuses provided with a function of authenticating a user.

In this type of image sending apparatus, ordinarily, an image processing apparatus in which a user performs an input operation is provided, and by the user performing an operation to pre-register recipient identification information based on display information that is displayed on an operation screen of a display unit, the recipient identification information in the operation is registered, and by performing an operation for sending to the registered recipient, sending to the recipient in the operation is executed.

For example, JP 2006-114992A discloses a communications terminal apparatus provided with an individual phone book only for valid users, a group phone book for valid users belonging to a group, and an all-purpose phone book usable independently of the users, and use of the individual phone book, group phone book, or all-purpose phone book is allowed based on the results of user authentication.

JP 2006-191192A discloses an image sending apparatus in which definition information that defines a send destination is stored, and when sending image data based on selected definition information, approval or disapproval of send processing is decided, and the image data is sent when send processing has been approved.

However, in conventional image forming apparatuses and image sending apparatuses, when the user performs an operation based on the display information displayed on the operation screen of the display unit, although useful information (for example, practical information that, although described in an operation manual or the like, is not displayed in the display unit and therefore although necessary to the user, cannot be immediately obtained, personal information of the user such as cautions, expertise information such as a specific operation method for a specific operation subject, and local information such as customary operating procedures in business) for that operation is necessary, the user that performs the operation cannot easily acquire useful information for that operation.

Specifically, in an image forming apparatus, when copying a document such as an order form, it may be standard practice to delete 1 cm of the border in a specific form, or when sending a document with an image sending apparatus, a practice of contacting the recipient by telephone after sending, depending on the recipient, may be necessary. In such cases, conventionally, per instance of copying, or per instance of sending, troublesome work such as adding a hand-written memo to the original is necessary, and this causes a decrease in the efficiency of work for operations such as a copy operation and a sending operation.

Furthermore, included among the useful information is information that, although useful to the user that performs an operation, is not useful to other users, or information (for example, information such as confidential business matters) that should be kept confidential from users other than the user that performs an operation. That is, in some cases it is sufficient that only the operating user can obtain the useful information.

### SUMMARY OF THE INVENTION

The present invention was made in consideration of the above problems, and it is an object thereof to provide an image processing apparatus in which only a user that performs an operation can easily acquire information useful to that user, so that the efficiency of work for the operation can be improved, and an image forming apparatus and an image sending apparatus that are provided with such an image processing apparatus.

In order to address the above problems, the invention provides an image processing apparatus provided with a display unit that displays an operation screen, the image processing apparatus including: a user authentication unit that performs user authentication; an input unit that inputs comment information to the operation screen of the display unit, for each user that has been authenticated by the user authentication unit; and an output unit that outputs, among comment information that has been input by the input unit, comment information of a user that has been authenticated by the user authentication unit. Also, the invention provides an image forming apparatus and an image sending apparatus that are provided with the above image processing apparatus according to the invention.

With the image processing apparatus, and image forming apparatus and image sending apparatus, according to the invention, the input unit inputs comment information useful to a user to an operation screen of the display unit for each user that has been authenticated by the user authentication unit, and the output unit outputs, among the comment information that has been input by the input unit, comment information of the user that has been authenticated by the user authentication unit.

In this way, according to the invention, by performing user authentication, inputting information useful to the user as comment information for an operation screen of the display unit, and outputting comment information of that user, it is possible for only that user to easily acquire information useful to the user, and to that extent, the efficiency of work for the operation can be improved. Furthermore, it is possible to prevent information that is not necessary to another user, or information that should be kept confidential from another user, from being acquired by the other user.

In an example mode of the invention, the input unit is made capable of inputting comment information for a function displayed in the operation screen of the display unit, and the output unit is made capable of outputting comment information that has been input by the input unit, associated with the displayed function.

In this mode, the input unit, in a system settings mode in which various settings are performed in advance, may be made capable of inputting comment information for a function displayed in an operation screen. Incidentally, there may be cases when the user desires to input the comment information in a function execution mode in which various functions are executed. In such a case, it is necessary to end the function execution mode and move to the system settings mode, and then input the comment information, so there is some burden when performing input work. From this viewpoint, in the invention, it is preferable that the input unit, in a function execution mode in which various functions are executed, is made capable of inputting comment information for a function displayed in an operation screen. By adopting such a configuration, the user can input the comment information in the function execution mode, and to that extent, it is possible to reduce the work burden.

In an example mode, the comment information includes text information (for example, a free text comment and/or a standard text comment).

In the invention, in an example mode, when the comment information includes text information, the input unit is made capable of inputting text comment information (for example, a free text comment and/or a standard text comment) for a function displayed in an operation screen of the display unit; and the output unit includes a display control unit that is capable of displaying the text comment information that has been input by the input unit in the display unit, associated with the function thereof.

In the invention, the following modes (a) to (c) can be cited as examples of a specific configuration of the display control unit.

(a) In an example mode, the display control unit is made capable of displaying all comment information corresponding to functions displayed in an operation screen of the display unit, associated with the displayed functions.

With this specific mode, the user can confirm the comment information for all functions displayed in the operation screen of the display unit.

(b) In an example mode, the display control unit, when selection/operation has been performed for a function displayed in an operation screen of the display unit, is made capable of displaying comment information for that function in the display unit.

With this specific configuration, the comment information for a function displayed in an operation screen of the display unit can be displayed only when the user has performed selection/operation for that function.

In the mode (b) above, the display control unit, when selection/operation has been performed for a function displayed in an operation screen of the display unit, is made capable of displaying comment information for that function in the display unit, and afterward, when next an operation has been performed to input the comment information, the input unit is made capable of executing an operation to input the comment information.

With this specific mode, the user can add to/update comment information displayed when selection/operation has been performed for a function displayed in an operation screen of the display unit after the user has confirmed that comment information.

(c) In an example mode, the display control unit, when an operation has been performed to output comment information for a function displayed in an operation screen of the display unit, is made capable of displaying the comment information in the display unit.

With this specific mode, it is possible to display comment information for a function displayed in an operation screen of the display unit only when the user desires to confirm that comment information.

In an example of the mode (c) above, the display control unit, when an operation has been performed to output comment information for a function displayed in an operation screen of the display unit, is made capable of displaying the comment information in the display unit, and afterward, when next an operation has been performed to input the comment information, the input unit is made capable of executing an operation to input the comment information.

With this specific mode, the user can add to/update comment information displayed when selection/operation has been performed for a function displayed in an operation screen of the display unit after the user has confirmed that comment information.

In the invention, it is preferable that the input unit is made capable of performing visual modification processing on the comment information, and the display control unit is made capable of displaying comment information on which visual modification processing has been performed by the input unit. Examples of this visual modification processing include processing such as a comment color designation, a comment font type, a comment text size, whether or not to display a comment border that surrounds a comment, color designation of the comment border, and a line type designation of the comment border.

With this specific mode, it is possible to effectively draw the user's attention to a comment by performing visual modification for the comment information.

In the invention, when displaying the comment information in a state in which a function has been displayed in an operation screen of the display unit, the comment information may be displayed in a location other than the function display, or the comment information may be displayed so as to conceal the function display. Of these alternatives, when the comment information is displayed in a state in which a function has been displayed in an operation screen of the display unit so as to conceal the function display, the function display is concealed by the comment information, so it is not possible to view the function display. To address this, in the invention, it is preferable that the display control unit is made capable of displaying the comment information for a predetermined fixed time period from the start of display. By doing so, even if the function display is concealed by the comment information, it is possible to view the function display after passage of the predetermined time period.

Incidentally, there may be cases when comment information necessary to a user other than the authenticated user exists in the comment information. From this viewpoint, in an example mode of the invention, the comment information includes output switching identification information that identifies whether to output the comment information only when a user is authenticated for the comment information, or to output the comment information to all users, the input unit is made capable of inputting the output switching identification information to the comment information, and the output unit is made capable of switching between outputting the comment information only when a user is authenticated for the comment information, and outputting the comment information to all users, based on the output switching identification information that has been input by the input unit.

With this specific mode, it is possible to provide comment information necessary to a user other than the authenticated user also to that other user.

In the invention, in an example mode, the input unit is made capable of inputting an output condition when outputting the comment information by the output unit, and the output unit is made capable of outputting the comment information based on the output condition that has been input by the input unit. Examples of this output condition include, for example, a setting condition of the display time when displaying the comment information by the display control unit for a predetermined fixed time period from the start of display, and a display condition regarding the manner of display of the comment information by the display control unit in the display unit (for example, a condition of which to select from above modes (a) to (c), or a condition of whether to use the output switching identification information).

As described above, according to the invention, by performing user authentication, inputting information useful to the user as comment information for an operation screen of the display unit, and outputting comment information of that user, it is possible for only a user that performs an operation to easily acquire information useful to that user, so that the efficiency of work for the operation can be improved. Furthermore, it is possible to prevent information that is not necessary to another user, or information that should be kept confidential from another user, from being acquired by the other user.

### BRIEF DESCRIPTION OF THE DRAWINGS

FIG. 1 is a schematic diagram that shows the overall configuration of an image processing system that is constructed using a digital multifunction peripheral according to an embodiment of the present invention.

FIG. 2 is a block diagram that shows the internal configuration of the digital multifunction peripheral.

FIG. 3 is a schematic diagram that shows the data structure of a function information management table.

FIG. 4 is a schematic diagram that shows the data structure of a comment information management table.

FIG. 5 is a schematic diagram that shows an example of an operation panel.

FIGS. 6A, 6B, and 6C are schematic diagrams that show an example of a screen selectively displayed when a system settings key shown in FIG. 5 has been operated by pressing the system settings key.

FIG. 7A is a schematic diagram that shows an example of a screen displayed in the display unit when performing settings of one-touch key assignment.

FIG. 7B is a schematic diagram that shows another example of a screen displayed in the display unit when performing settings of one-touch key assignment.

FIG. 7C is a schematic diagram that shows a variation of the screen shown in FIG. 7B.

FIG. 8 is a schematic diagram that shows an example of a comment information input screen displayed when a comment information key shown in FIG. 6A has been operated by pressing the comment information key.

FIG. 9 is a flowchart that shows the flow of processing to input comment information for function information displayed in an operation screen in a system settings mode.

FIG. 10 is a schematic diagram that shows an example of a function operation screen displayed when an image send key has been operated by pressing the image send key in an initial screen shown in FIG. 5.

FIG. 11 is a schematic diagram that shows an example of an operation screen displayed when a function selection key has been operated by pressing a function selection key in the function operation screen shown in FIG. 10.

FIG. 12 is a schematic diagram that shows an example of an operation screen displayed when a special function key has been operated by pressing the special function key in the initial screen shown in FIG. 5.

FIG. 13A illustrates an example of a comment information input operation in a function execution mode, and is a schematic diagram that shows another example of an operation screen displayed when a function selection key has been operated by pressing the function selection key in the function operation screen shown in FIG. 10.

FIG. 13B illustrates an example of a comment information input operation in a function execution mode, and is a schematic diagram that shows an example of a comment input screen displayed when a comment information input key has been operated by pressing the comment information input key in the operation screen shown in FIG. 13A.

FIG. 14A illustrates an example of a comment information input operation in a function execution mode, and is a schematic diagram that shows another example of an operation screen displayed when the special function key has been operated by pressing the special function key in the initial screen shown in FIG. 5.

FIG. 14B illustrates an example of a comment information input operation in a function execution mode, and is a schematic diagram that shows an example of a comment input screen displayed when a comment information input key has been operated by pressing the comment information input key in the operation screen shown in FIG. 14A.

FIG. 15 is a schematic diagram that shows another example of an operation screen displayed when the function selection key has been operated by pressing the function selection key in the function operation screen shown in FIG. 10.

FIG. 16 is a schematic diagram that shows another example of an operation screen displayed when the special function key has been operated by pressing the special function key in the initial screen shown in FIG. 5.

FIG. 17A illustrates an example of a comment information input operation in a function execution mode, and is a schematic diagram that shows still another example of an operation screen displayed when the function selection key has been operated by pressing the function selection key in the function operation screen shown in FIG. 10.

FIG. 17B illustrates an example of a comment information input operation in a function execution mode, and is a schematic diagram that shows an example of a comment input screen displayed when a comment information input key has been operated by pressing the comment information input key in the operation screen shown in FIG. 17A.

FIG. 18A illustrates an example of a comment information input operation in a function execution mode, and is a schematic diagram that shows still another example of an operation screen displayed when the special function key has been operated by pressing the special function key in the initial screen shown in FIG. 5.

FIG. 18B illustrates an example of a comment information input operation in a function execution mode, and is a schematic diagram that shows an example of a comment input screen displayed when a comment information input key has been operated by pressing the comment information input key in the operation screen shown in FIG. 18A.

FIG. 19 is a flowchart that shows the flow of processing to input and display comment information for function information displayed in an operation screen in a function execution mode.

FIG. 20 shows example comments that are input in the operation screens of various functions.

FIG. 21 shows a login screen displayed in the display unit when performing user authentication.

FIG. 22 is a schematic diagram that shows a detailed view of part of the comment information management table shown in FIG. 4.

### DESCRIPTION OF THE PREFERRED EMBODIMENTS

Hereinafter, an embodiment in which an image forming apparatus and an image sending apparatus provided with an image processing apparatus according to an embodiment of the present invention are applied to a digital multifunction peripheral having a print function, a copy function, a facsimile send/receive function, and so forth will be specifically described with reference to the attached drawings that show that embodiment. The embodiment below is only one specific example of the invention, and is not of a nature limiting the technical scope of the invention.

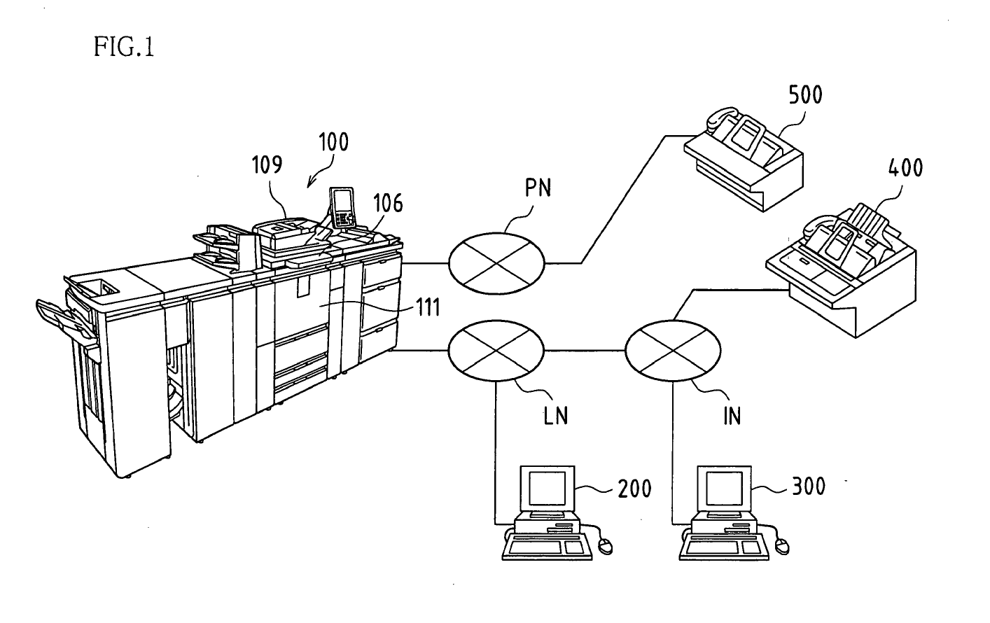

FIG. 1 is a schematic diagram that shows the overall configuration of an image processing system that is constructed using a digital multifunction peripheral according to an embodiment of the present invention.

FIG. 1 shows a digital multifunction peripheral 100 according to the present embodiment. Various external devices are connected to this digital multifunction peripheral 100 via a communications network. For example, an external computer 200 such as a personal computer is connected to a communications network LN that is deployed as a local communications network, and an external computer 300 and an internet facsimile apparatus 400 (referred to below as simply the facsimile apparatus 400) are connected to an internet network IN that is connected via a connection means such as a gateway, not shown. Also, an external facsimile apparatus 500 is connected via a public telephone network PN.

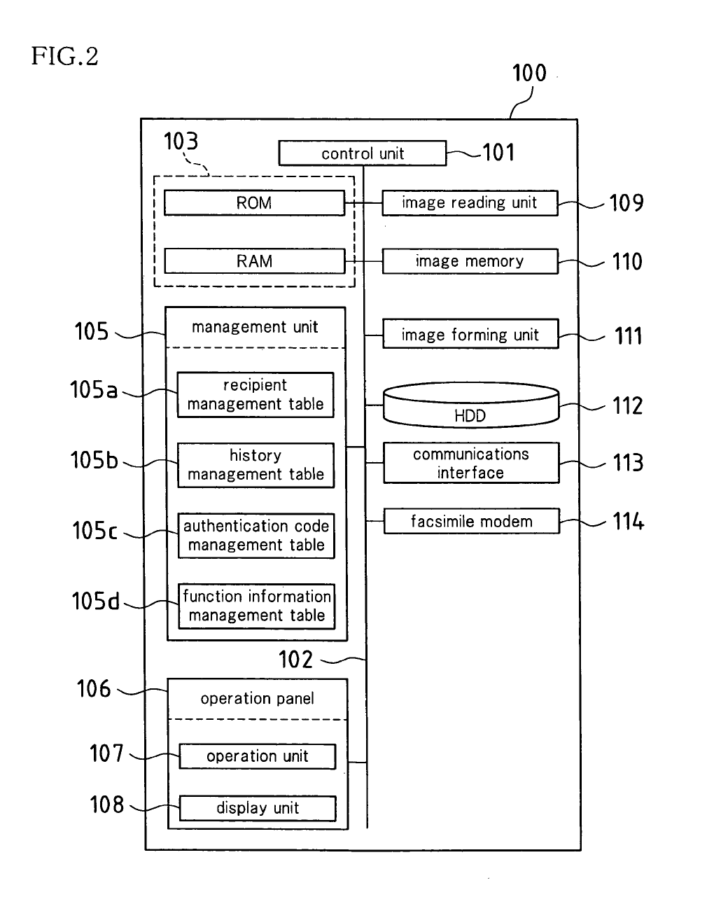

FIG. 2 is a block diagram that shows the internal configuration of the digital multifunction peripheral 100. The digital multifunction peripheral 100 is provided with the control unit 101 that includes a processing apparatus such as a CPU, and a main storage unit 103 that includes memories such as a ROM and a RAM. The control unit 101 also functions as a control unit of the image processing apparatus according to this embodiment of the invention.

More specifically, the digital multifunction peripheral 100, by the CPU of the control unit 101 loading a control program that has been pre-stored in the ROM of the main storage unit 103 into the RAM of the main storage unit 103 and executing that loaded control program, controls hardware that has been connected via a bus 102, and thus operates that hardware as a whole as an image forming apparatus and an image sending apparatus.

Following is a description of the configurations of various hardware connected to the bus 102. The management unit 105 is configured from a nonvolatile semiconductor memory, and part of the storage area in that memory is used for a recipient management table 105a in which recipient identification information such as electronic mail addresses and facsimile numbers of destinations is managed, a history management table 105b in which a history of executed processes is managed, an authentication code management table 105c in which authentication codes (here, user identification codes and passwords that identify users) are managed, and a function information management table 105d in which display information of various functions is managed.

The operation panel 106 is configured from an operation unit 107 for receiving operation from a user, and a display unit 108 for displaying information to be notified to the user. The operation unit 107 is provided with various operation members, such as various operation keys and number keys for receiving input such as a function switching operation, number of output pages in print processing, magnification change in copy processing, and send destination in facsimile sending processing. The display unit 108 is provided with a display apparatus (for example, a liquid crystal display apparatus), and displays display information such as the operating status of the digital multifunction peripheral 100 and settings values that have been input from the operation unit 107. Also, the display unit 108 is provided with a touch panel-type input apparatus having software keys configured so as to receive various selection operations by a user's input operation to a display screen (for example, a pressing operation).

The image reading unit 109 is provided with an original platen where an original to be read is placed, a light source that applies light to the original to be read, an image sensor such as a CCD (Charge Coupled Device), and an optical member such as an AD converter (all not shown). In the image reading unit 109, an image of the original that has been placed at a predetermined reading position is formed on the image sensor and converted to an analog electrical signal, the obtained analog electrical signal is AD-converted to a digital signal by the AD converter, and digital-format image data is produced by performing correction of the light distribution properties of the light source, sensitivity variation of the image sensor, and so forth during original read on the obtained digital signal.

The image memory 110 is, for example, a volatile page memory, and temporarily stores various image data, such as image data acquired by the image reading unit 109, image data decompressed from a print job, and image data decompressed from facsimile data. In the image memory 110, image data that has been temporarily stored is transferred to a transfer destination according to the intended use of that data by an instruction of the control unit 101. That is, image data that has been temporarily stored is transferred to the image forming unit 111 when image forming on paper will be performed, transferred to the large-capacity storage memory (here, the hard disk apparatus (HDD)) 112 when the data will be saved using a filing function, transferred to the communications interface 113 after being attached to an electronic mail that includes recipient address information when the data will be sent as an electronic mail, and transferred to the facsimile modem 114 when the data will be sent as facsimile data.

The image forming unit 111 forms an image on paper based on image data that has been transferred from the image memory 110. More specifically, the image forming unit 111 is provided with image forming members (all not shown) such as a charging unit that charges a photosensitive drum to a predetermined potential, a laser writing apparatus that emits laser light according to image data that has been received from outside to produce an electrostatic latent image on the photosensitive drum, a development unit that supplies toner to the electrostatic latent image that has been formed on the surface of the photosensitive drum to form a visible image, and a transfer unit that transfers the toner image formed on the surface of the photosensitive drum onto paper. Also, the image forming unit 111 forms an image desired by a user on paper using an electrophotographic method. However, other than forming an image by an electrophotographic method employing a laser writing apparatus, the image forming unit 111 may form an image by another method, such as an inkjet method, a thermal transfer method, or a sublimation method.

The HDD 112 is a hard disk apparatus that has a hard disk controller and a disk-shaped magnetic recording medium. In the HDD 112, by the control unit 101 giving an instruction to the hard disk controller, data writing processing or reading processing is performed. Also, in the HDD 112, a part of a storage area is used as a data area for storing image data, and when a request has been received via the operation panel 106, or when a request has been received from the external computer 200 or 300 via the communications interface 113, the image data stored in the data area is read out. Accordingly, in this digital multifunction peripheral 100, when it is necessary to execute print processing again because of a print processing failure, inadequate output copies, or the like, the image data stored in the data area can be read out as necessary to execute print processing. Also, in this embodiment, in the HDD 112, it is possible to use a part of the storage area for a comment information management table 112a (see FIG. 4, described below.)

The communications interface 113 is provided with a communications interface compliant with the communications standards of the communications network LN, and can be connected to the communications network LN and the internet network IN. With the communications interface 113 provided with this configuration, a print job can be received from the external computer 200 on the connected communications network LN, and also, electronic mail sent from the external computer 300 on the internet network IN can be received, and facsimile data sent from the facsimile apparatus 400 can be received. Also, with the communications interface 113, information to be notified to the external computer 200 can be sent, and also, electronic mail can be sent to the external computer 300 on the internet network IN, and facsimile data can be sent to the facsimile apparatus 400. Thus, the communications interface 113 can perform control of sending/receiving of various data.

The facsimile modem 114 is provided with a network termination circuit for connecting to the external facsimile apparatus 500 via the public telephone network PN, and is capable of sending/receiving facsimile data to/from the connected facsimile apparatus 500. More specifically, the facsimile modem 114 is provided with a decoding circuit for decoding received facsimile data, and an encoding circuit for encoding facsimile data to be sent. Also, the facsimile modem 114 is capable of executing this sort of facsimile data encoding processing and decoding processing, as well as sending/receiving processing of encoded facsimile data.

### Description of Distinguishing Portions of the Invention

In this embodiment, the control unit 101 is capable of executing a system settings mode in which various settings are performed in advance according to the intended use or usage conditions, and a function execution mode in which various functions are executed. The settings performed in the system settings mode are not particularly limited, and examples of such settings include one-touch registration, group registration, and settings for special functions. Also, the functions performed in the function execution mode are not particularly limited, and examples of such functions include various print functions such as duplex printing, color printing, reduced/enlarged printing, and a job program registration function, and various send functions such as facsimile sending using a public phone line or the Internet.

The digital multifunction peripheral 100 according to this embodiment is provided with a user authentication unit that performs user authentication, an input unit that inputs comment information to the operation screen of the display unit 108, for each user that has been authenticated by the user authentication unit, and an output unit that outputs, among comment information that has been input by the input unit, comment information of a user that has been authenticated by the user authentication unit. Specifically, this digital multifunction peripheral 100 is provided with an operation unit 107 operated by a user to input operation information, an authentication information storage unit (here, an authentication code management table 105c) that stores user authentication information, a function information storage unit (here, a function information management table 105d) that stores display information (function information) of various functions, a comment information storage unit (here, a comment information management table 112a) that stores comment information, a display unit 108 in which a plurality of operation screens are selectively displayed based on the function information that has been stored in the function information storage unit, and a control unit (here, the control unit 101 that controls the entire digital multifunction peripheral 100) that governs control of the image processing apparatus. Note that in this embodiment, the authentication information storage unit is configured with the authentication code management table 105c of the management unit 105, the function information storage unit is configured with the function information management table 105d of the management unit 105, and the comment information management unit is configured with the comment information management table 112a, which is a part of the HDD 112.

The control unit 101 will be described in more detail later, but is configured with a user authentication unit that performs user authentication using user authentication information stored in the authentication information storage unit (below, referred to as the authentication code management table 105c), an input control unit that inputs comment information for function information (here, function information stored in the function information management table 105d) displayed in an operation screen of the display unit 108 for each user that has been authenticated by the user authentication unit, a storage control unit that stores comment information that has been input by the input control unit, associated with the function information thereof, for each user, in the comment information storage unit (below, referred to as the comment information management table 112a), a read control unit that reads out the comment information of each user that has been stored in the comment information management table 112a by the storage control unit along with the function information thereof from the comment information management table 112a, and an output control unit that outputs, among the comment information that has been read out from the comment information management table 112a by the read control unit, comment information of a user that has been authenticated by the user authentication unit, associated with the function information thereof.

According to the digital multifunction peripheral 100 according to this embodiment, user authentication is performed, and as the comment information for the operation screen of the display unit 108, information useful to the authenticated user (for example, a comment “delete 1 cm of the border” in the case of copying a document such as an order form, or a comment “contact by phone after sending” in the case of sending a document) is input, and the comment information of that user is output. By doing so, when the user performs an operation based on display information displayed on the operation screen of the display unit 108, information useful for that operation can easily be acquired by only that user, so it is possible to reduce input errors and improve operability. Furthermore, because the comment information of the authenticated user is output, it is possible to not output information that is unnecessary to another user or information should not be provided to another user (particularly information that should be kept confidential).

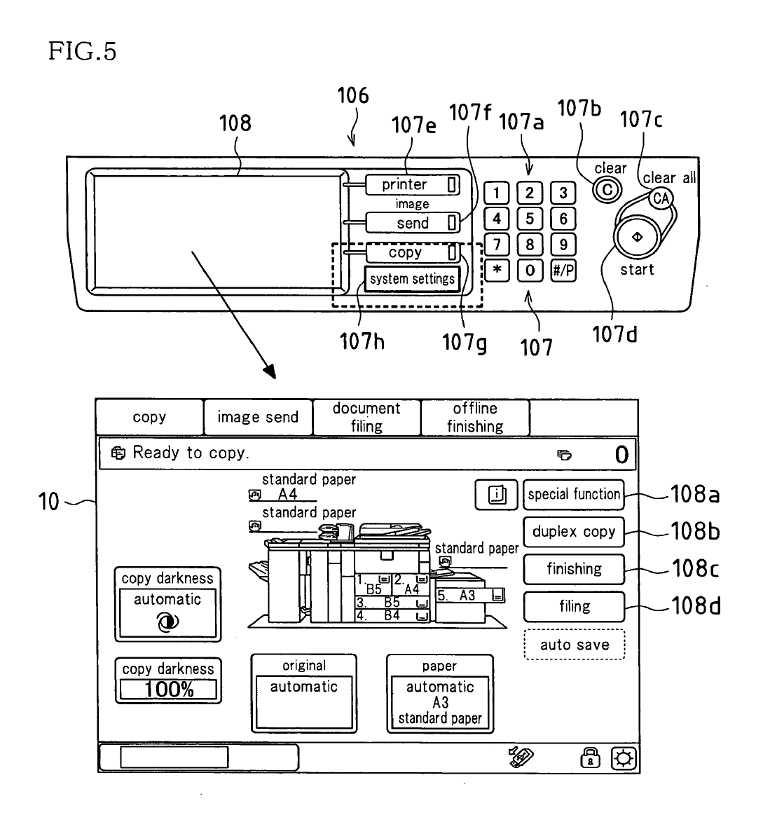

In this embodiment, the comment information includes text information. The input control unit inputs text comment information for the function information displayed in the operation screen of the display unit 108 (see FIG. 5, described below). The output control unit is configured as a display control unit that displays the text comment information read out from the comment information management table 112a by the read control unit in the display unit 108, associated with the function information thereof. Accordingly, even if a plurality of users have input comment information for the function information displayed in the operation screen of the display unit 108, by displaying the comment information of the authenticated user in the display unit 108, the comment information displayed in the operation screen can be designated as comment information of the authenticated user, so it is possible to avoid display complication in which this comment information is displayed intermingled with the comment information of another user.

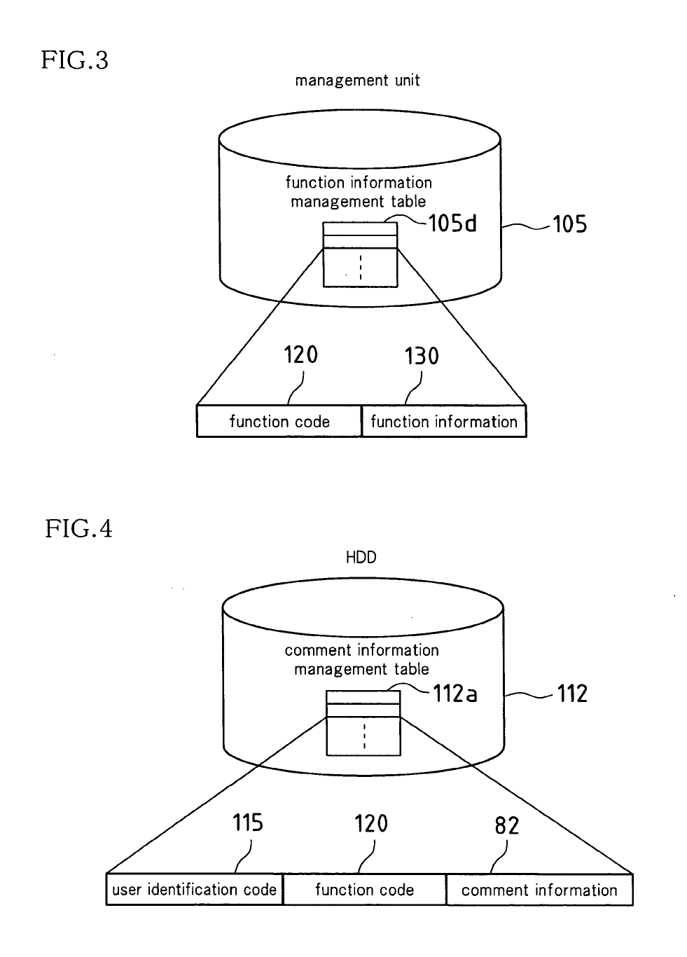

FIG. 3 is a schematic diagram that shows the data structure of the function information management table 105d, and FIG. 4 is a schematic diagram that shows the data structure of the comment information management table 112a.

As shown in FIG. 3, function information 130 is stored associated with a function code 120 that identifies function information in the function information management table 105d. As shown in FIG. 4, comment information 82 is stored associated with the function code 120 for each user identification code 115 that identifies a user in the comment information management table 112a. Thus, the comment information 82 can be associated with the function information 130 for each user (each user identification code 115).

(System Settings Mode)

In the system settings mode, it is possible to set whether or not to perform user authentication. Here, user authentication is set, and so login is performed when using the digital multifunction peripheral 100.

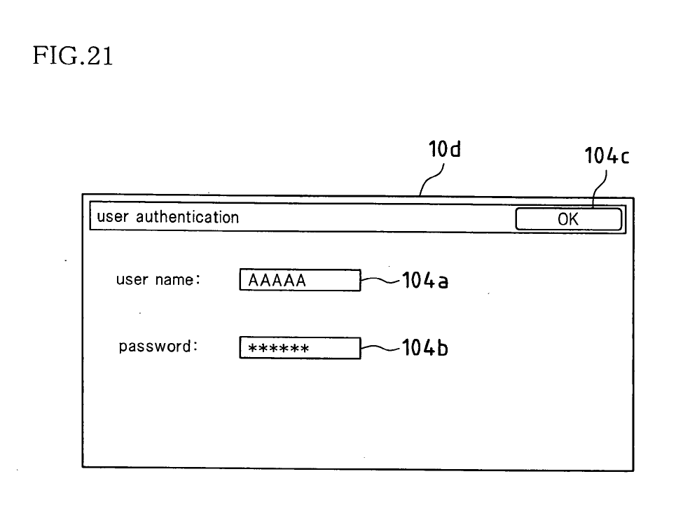

FIG. 21 shows a login screen displayed in the display unit 108 when performing user authentication.

As shown in FIG. 21, the control unit 101 is made capable of inputting a user name (user identification code 115) and a password in a login screen 10d (specifically input boxes 104a and 104b), and when a user name and a password are input in the login screen 10d and fixed (specifically, when an OK key 104c is operated by pressing the OK key 104c), it is possible to perform user authentication by comparing these to a pre-registered (specifically, pre-stored in the authentication code management table 105c) user name and password.

In this embodiment, the input control unit configured by the control unit 101, in the system settings mode, for each authenticated user, inputs comment information for function information displayed in the operation screen.

This will be described, giving as an example a case where, in the system settings mode, comment information is input when registering a recipient to a one-touch key (shortcut key), and then described for an example case where comment information is input for various functions (specifically, a border deletion function).

First, the operation when registering an electronic mail address and a facsimile number to a one-touch key will be described using a screen displayed in the display unit 108 of the operation panel 106.

FIG. 5 is a schematic diagram that shows an example of the operation panel 106. As described above, the operation panel 106 is configured from the operation unit 107 provided with various hardware keys and the display unit 108 constituted from a display apparatus and a touch-panel input apparatus. As hardware keys, the operation unit 107 is provided with a numeric keypad 107a for numerical input, a clear key 107b for clearing a settings value that has been input, a clear all key 107c for clearing all of various settings that have been input, and a start key 107d that receives an instruction to start copying, start sending, and so forth. Additionally, the operation unit 107 is provided with function switching keys 107e, 107f, and 107g that respectively switch to a print function, a send function, and a copy function, and also a system settings key 107h that receives settings by a user. The lower part of FIG. 5 shows an enlarged view of an initial screen 10 for awaiting copy processing displayed in the display unit 108. Various keys 108a to 108d configured as software keys are disposed in the initial screen 10. The control unit 101 is configured to be capable of performing setting of a special function such as border deletion, setting of a duplex copy function, setting of a finishing function such as staple processing, and setting of a filing function that saves image data, respectively, by these keys 108a to 108d being operated by pressing the keys 108a to 108d.

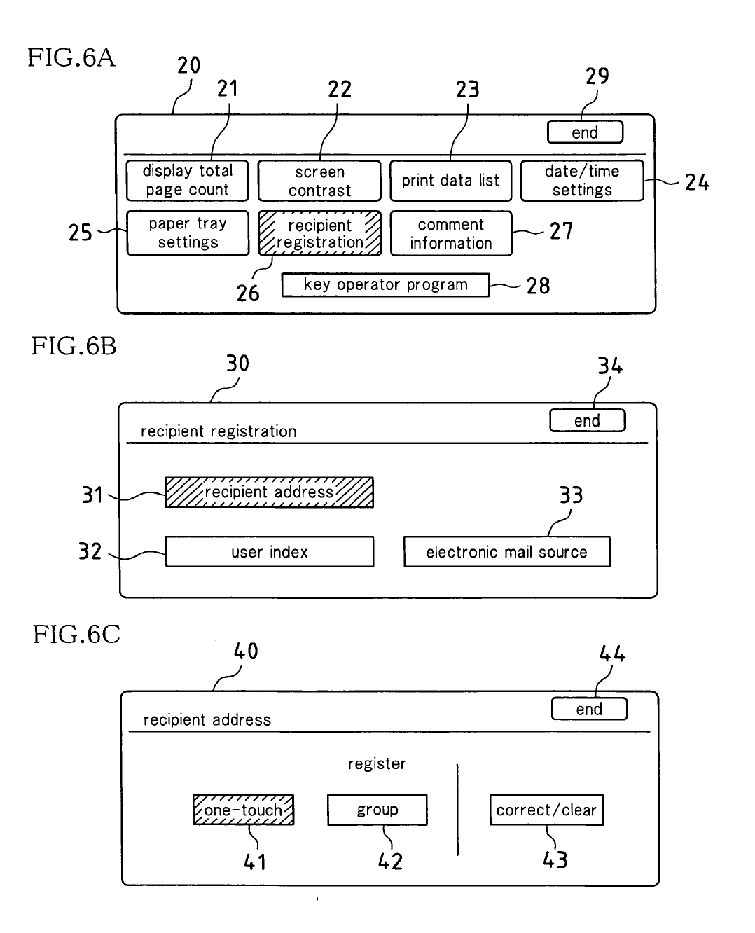

FIGS. 6A to 6C are schematic diagrams that show an example of a screen selectively displayed when the system settings key 107h shown in FIG. 5 has been operated by pressing the system settings key 107h.

When the system settings key 107h of the operation panel 106 shown in FIG. 5 has been operated by pressing the system settings key 107h, the control unit 101 displays a settings menu screen 20 shown in FIG. 6A instead of the initial screen 10 as shown in the lower part of FIG. 5 in the display unit 108. Various keys 21 to 28 configured as software keys are disposed in the settings menu screen 20.

The control unit 101 can perform, respectively, display of the total number of pages that have been printed out, setting of screen contrast, a request for output of various data lists, setting of date and time, setting of a paper tray, registration of a recipient when sending data, input of comment information, and various settings by an apparatus administrator by these keys 21 to 28 being operated by pressing the keys 21 to 28. Also, when an end key 29 disposed in the upper part of the settings menu screen 20 has been operated by pressing the end key 29, the settings menu screen 20 is closed, and the initial screen 10 displayed in the lower part of FIG. 5 is displayed in the display unit 108. Here, the comment information 82 can be input by operation of the various keys 21 to 27 by pressing the various keys 21 to 27. First, by way of example, a case of input of comment information by operating a recipient registration key 26 by pressing that key will be described.

When the recipient registration key 26 has been operated by pressing the recipient registration key 26 in the settings menu screen 20 shown in FIG. 6A, a recipient registration screen 30 shown in FIG. 6B is displayed instead of the settings menu screen 20 in the display unit 108. An address settings key 31 for setting communications addresses (facsimile number and electronic mail address) of a recipient, a user index settings key 32 for creating or correcting an address index, and a send source settings key 33 that sets information for the send source of electronic mail are disposed in the recipient registration screen 30. When the keys 31 to 33 have been operated by pressing the keys 31 to 33, the operation content in the recipient registration screen 30 is fixed, and when an end key 34 disposed in the upper part of the screen has been operated by pressing the end key 34, processing to return to the above settings menu screen 20 is performed.

When an address settings key 31 has been operated by pressing the address settings key 31 in the recipient registration screen 30 shown in FIG. 6B, a registration content settings screen 40 shown in FIG. 6C is displayed instead of the recipient registration screen 30 in the display unit 108. A one-touch registration key (key assignment key) 41 for setting the assignment of a one-touch key to a recipient communications address, a group registration key 42 for grouping communications addresses, and a correct/clear key 43 for correcting or clearing registration content are disposed in the registration content settings screen 40. When the keys 41 to 43 have been operated by pressing the keys 41 to 43, the operation content in the registration content settings screen 40 is fixed, and when an end key 44 disposed in the upper part of the screen has been operated by pressing the end key 44, processing to return to the recipient registration screen 30 shown in FIG. 6B is performed.

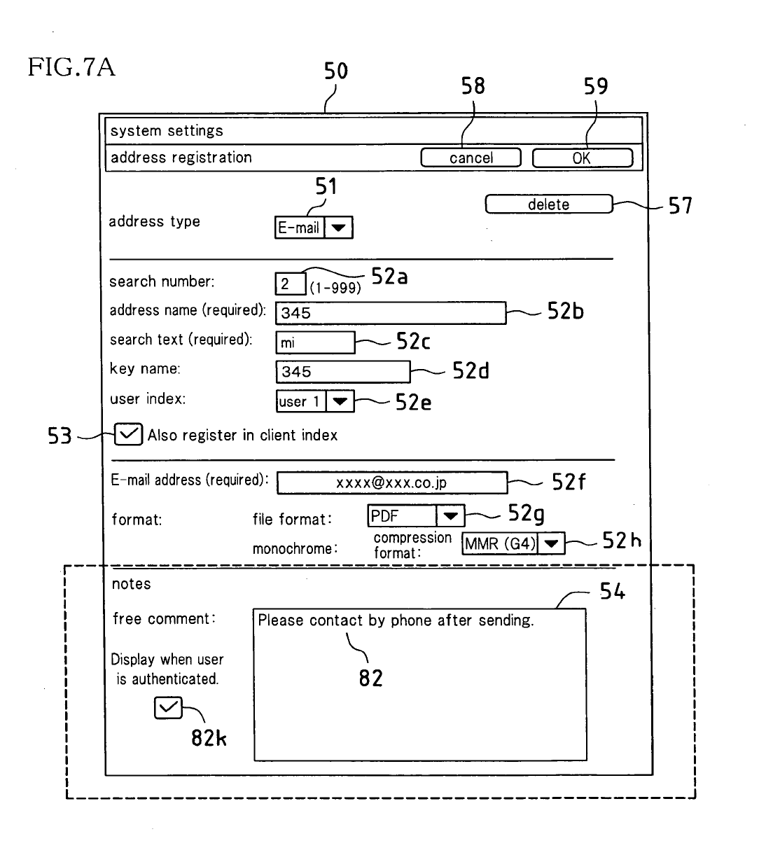

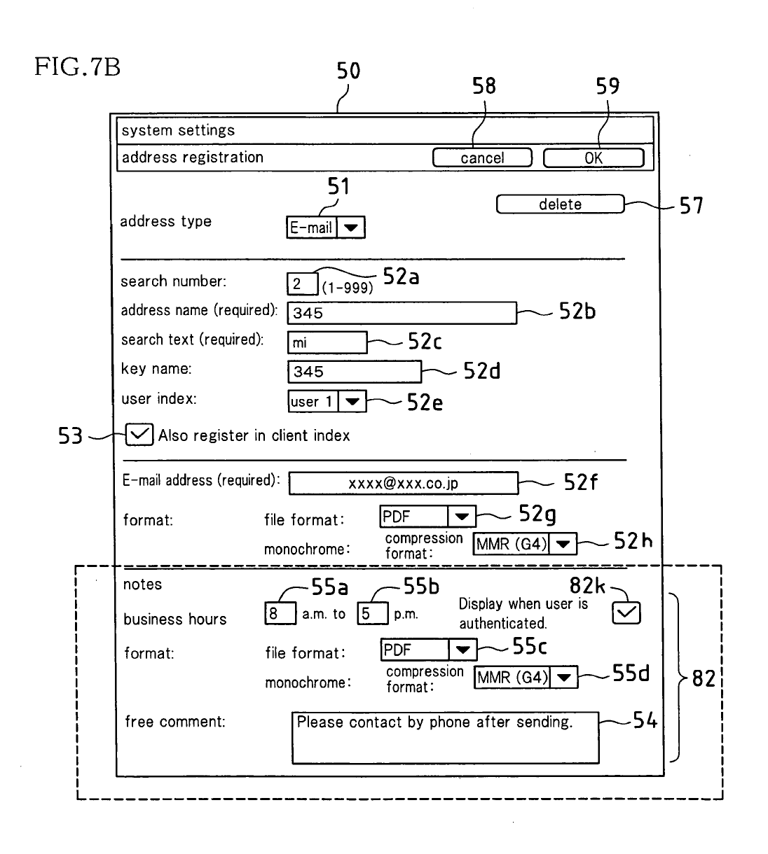

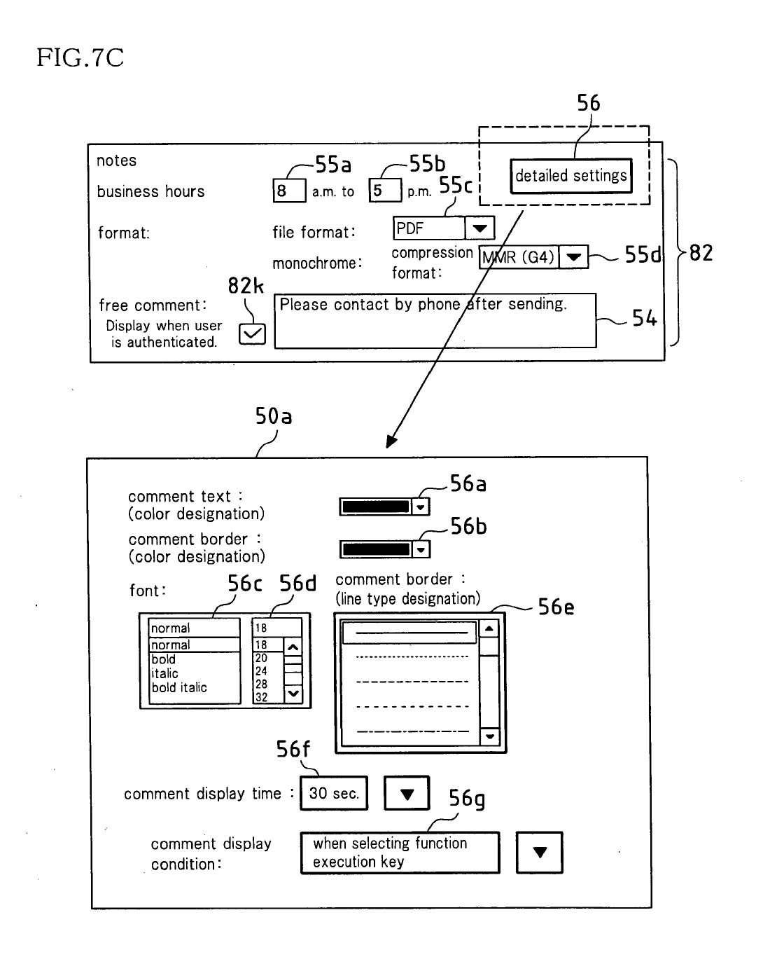

FIG. 7A is a schematic diagram that shows an example of a screen displayed in the display unit 108 when performing settings of one-touch key assignment.

When the one-touch registration key 41 has been operated by pressing the one-touch registration key 41 in the registration content settings screen 40 shown in FIG. 6C, an address settings screen 50 shown in FIG. 7A is displayed instead of the registration content settings screen 40 in the display unit 108.

FIG. 7A shows an example of an address settings screen for assigning a one-touch key to an electronic mail address.

A selection key (here, a pull-down menu key) 51 for selecting a destination type of ‘E-mail’ or ‘fax’, recipient registration boxes 52a to 52h for inputting recipient registration content, and a selection key (here, a checkbox) 53 that sets input of content in a client index are disposed in the address settings screen 50 shown in FIG. 7A.

When ‘fax’ has been selected by operating the selection key 51, a facsimile number can be set, and when ‘E-mail’ has been selected, an electronic mail address can be set.

In the recipient registration boxes 52a to 52h, respectively, it is possible to input a search number used to search for a recipient, a recipient name, search text used to search for a recipient, a key name for displaying in an address book separate from a destination name, a user index type for use in an address book screen, a recipient electronic mail address or facsimile number, an image data file format, and an image data compression format. Also, when a check has been entered in the checkbox 53, a setting to display in a client tag is performed, and when a check is not entered in the checkbox 53, a setting to not display in a client tag is performed.

When a delete key 57 in the upper part of the screen has been operated by pressing the delete key 57, the registration content is deleted, and when a cancel key 58 has been operated by pressing the cancel key 58, processing to return to the settings menu screen 20 shown in FIG. 6A is performed, and when an OK key 59 has been operated by pressing the OK key 59, the input content of the address settings screen 50 is fixed, and processing to return to the settings menu screen 20 shown in FIG. 6A is performed.

The comment information 82 is input in the comment input box 54. In this embodiment, the comment information 82 includes a free comment that the user can write as desired. The input control unit configured by the control unit 101 is made capable of inputting a free comment for the function information displayed in the operation screen 50 of the display unit 108. Also, the display control unit configured by the control unit 101 is made capable of displaying the free comment that has been input by the input control unit, associated with the function thereof in the display unit 108.

In this example, user individual comment information 82 is input to the comment input box 54, such as a note “contact by telephone after sending” for recipient 345.

In the present embodiment, the comment information 82 includes output switching identification information 82a that identifies whether to output the comment information 82 only when a user is authenticated for the comment information, or to output the comment information 82 to all users. Also, the input control unit configured by the control unit 101 is capable of inputting the output switching identification information 82a to the comment information 82.

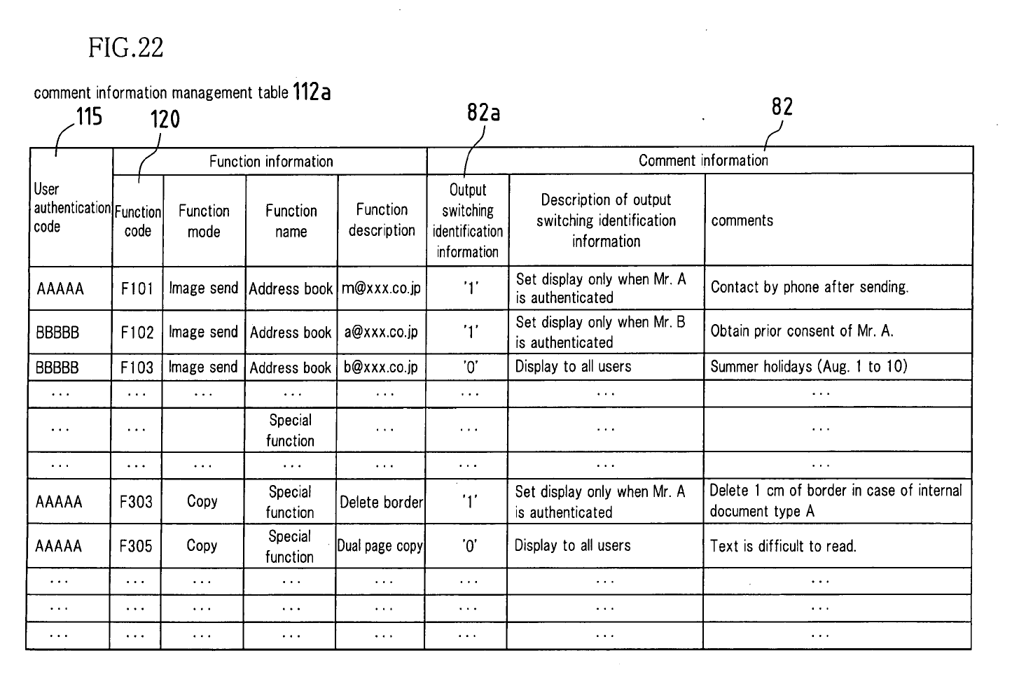

FIG. 22 is a schematic diagram that shows a detailed view of part of the comment information management table 112a shown in FIG. 4.

Specifically, as shown in FIG. 22, the input control unit is made capable of, when outputting the comment information 82 only when a user is authenticated for the comment information 82, selecting/inputting an authenticated output code (here, ‘1’) in the output switching identification information 82a, and when outputting the comment information 82 to all users, selecting/inputting an all user output code (here, ‘0’) in the output switching identification information 82a.

The output unit control unit configured by the control unit 101 is capable of switching between outputting the comment information 82 only when a user is authenticated for the comment information 82, and outputting the comment information 82 to all users, based on the output switching identification information 82a that has been input by the input control unit.

Specifically, the output control unit is made capable of outputting the comment information 82 only when a user is authenticated for the comment information 82 in a case where an authenticated output code (here, ‘1’) has been selected/input in the output switching identification information 82a of the comment information 82, and on the other hand, outputting the comment information 82 to all users in a case where an all user output code (here, ‘0’) has been selected/input in the output switching identification information 82a of the comment information 82.

With this configuration, by selecting the all user output code (here, ‘0’) for the output switching identification information 82a of the comment information 82, it is possible to provide the comment information 82 to all users. Thus, it is possible to provide the comment information 82 also to users other than an authenticated user.

In this example, a selection key (here, a check box) 82k that sets whether to use authenticated output or all user output is disposed in the address settings screen 50 shown in FIG. 7A. When the selection key 82k is selected (here, checked), the authenticated output code (here, ‘1’) is input in the output switching identification information 82a, and on the other hand, when the selection key 82k is not selected (here, not checked), the all user output code (here, ‘0’) is input in the output switching identification information 82a. This operation is the same in later-described FIGS. 7B, 7C, 8A, 8B, 13A, 13B, 14A, 14B, 17A, 17B, 18A, and 18B, and a description of that operation is omitted below.

FIG. 7B is a schematic diagram that shows another example of a screen displayed in the display unit 108 when performing settings of one-touch key assignment. In FIG. 7B, the same elements as in FIG. 7A are given the same reference numerals, and a description thereof is omitted here.

In the address settings screen 50 shown in FIG. 7B, the comment information 82 includes a standard comment in which a predetermined phrase has been set in advance. The input control unit configured by the control unit 101 can input a standard comment for function information displayed in the operation screen 50 of the display unit 108. Also, the display control unit configured by the control unit 101 can display the standard comment that has been input by the input control unit, associated with the function thereof in the display unit 108.

In this example, the standard comment includes the business hours (start time and end time) of the recipient, file format of attached image data, and compression format of attached image data. In comment input boxes 55a to 55d, respectively, user individual information such as notes regarding business start time, business end time, file format, and compression format are input.

FIG. 7C is a schematic diagram that shows a variation of the screen shown in FIG. 7B. In FIG. 7C, the same elements as in FIG. 7B are given the same reference numerals, and a description thereof is omitted here. Also, in FIG. 7C, the comment input box portion of the address settings screen 50 is shown above, and a detailed settings screen 50a is shown below.

In the comment input box shown in FIG. 7C, by operating a detailed settings key 56 by pressing the detailed settings key 56, detailed settings of the comment information 82 can be performed.

Here, the input control unit configured by the control unit 101 performs visual modification processing on the comment information 82, and the display control unit configured by the control unit 101 displays the comment information 82 on which visual modification processing has been performed by the input control unit. Also, the input control unit inputs display conditions when displaying the comment information 82 in the display unit 108 with the display control unit, and the display control unit displays the comment information 82 based on the display conditions that have been input by the input control unit.

In this example, the comment information 82 includes information of visual modification processing, such as a designated color of comment text, a designated color of a comment border, a comment text font type, a comment text size, and a designated line type of the comment border including information of whether or not to display a comment border. In comment input boxes 56a to 56e, respectively, a comment text color, a comment border color, a comment text font type, a comment text size, and a comment border line type (no comment border in the case of selecting no line type) are input.

Also, settings for display conditions when displaying the comment information 82 in the display unit 108 include setting of a comment display time when displaying the comment information 82 for only a predetermined fixed time from the start of display (for example, setting of any time period from 1 to 30 seconds), as described below, and setting of a display condition with respect to the manner of display of comment information in the display unit 108 (for example, setting of either display when selecting a function execution key or display when selecting a comment display key, or setting of whether or not to use the output switching identification information 82a), as described below. The comment display time and comment display condition are entered in the comment input boxes 56f and 56g, respectively.

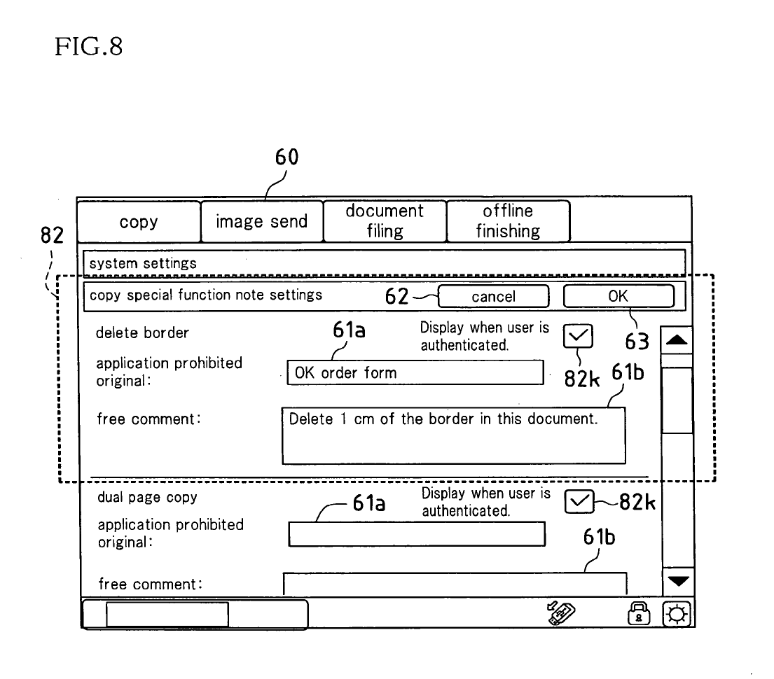

Next is a description of input of comment information for various functions (for example, a function such as copy special function note settings or a dual page copy function). When a comment information key 27 has been operated by pressing the comment information key 27 in the settings menu screen 20 shown in FIG. 6A, a comment information input screen 60 shown in FIG. 8 is displayed instead of the settings menu screen 20 in the display unit 108.

FIG. 8 is a schematic diagram that shows an example of a comment information input screen displayed when the comment information key 27 shown in FIG. 6A has been operated by pressing the comment information key 27.

In the comment information input screen 60 shown in FIG. 8, for respective function information, a standard comment input box 61a for inputting standard items (for example, a type of application prohibited original for which printing with this function is prohibited) and a free comment input box 61b for inputting a free comment are disposed. Here, the various function information is displayed downward in a list, so that scrolling display of function information that is not presently viewable in the display screen is possible.

When a cancel key 62 in the upper part of the screen has been operated by pressing the cancel key 62, processing to return to the settings menu screen 20 shown in FIG. 6A is performed, and when the OK key 63 has been operated by pressing the OK key 63, the input content in the comment information input screen 60 is fixed, and processing to return to the settings menu screen 20 shown in FIG. 6A is performed.

In this example, a document type ‘OK order form’ is entered for the comment of the standard item “application prohibited original” of this copy special function in the comment input box 61a, and the text “Please delete 1 cm of the border in this document . . . ” for this copy special function is entered in the comment input box 61b.

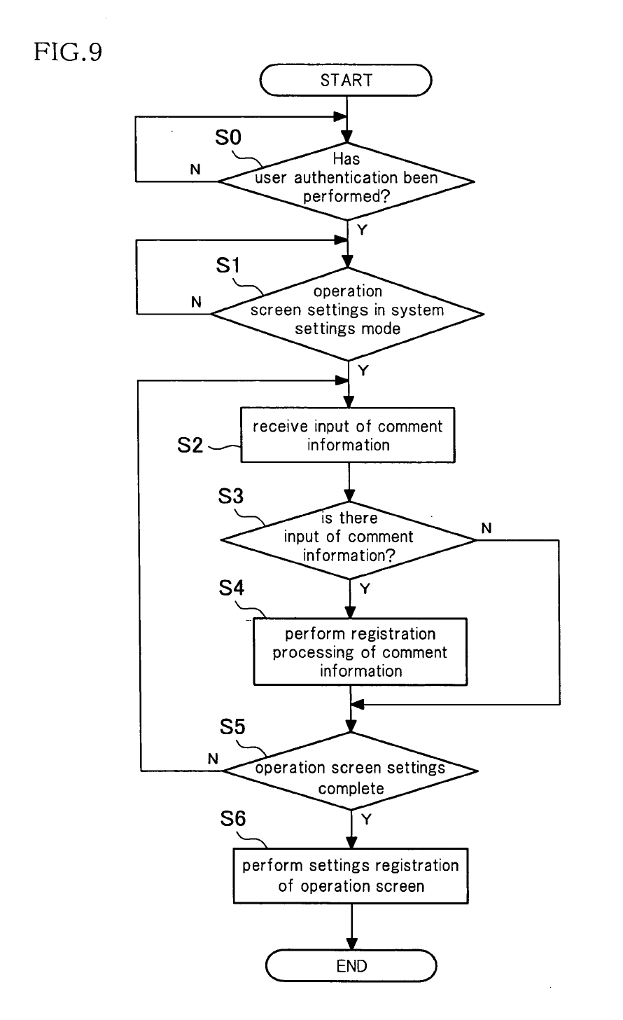

Next is a description of the operation flow of processing to input such comment information 82 for function information displayed in an operation screen in the system settings mode, with reference to FIG. 9.

FIG. 9 is a flowchart that shows the flow of processing to input the comment information 82 for function information displayed in an operation screen in the system settings mode.

In the processing shown in FIG. 9, first, user authentication is performed in a login screen (Step S0). Specifically, input of a user name (user identification code 115) and a password in the login screen is awaited (Step S0: N), user authentication is performed by the user name and password being input (Step S0: Y), and then the routine moves to Step S1. Next, a settings request of an operation screen in the system settings mode is awaited (for example, an address book registration request or a request to make settings of various functions)(Step S1: N), and when there is such a settings request (Step S1: Y), input of the comment information 82 (for example, see FIGS. 7A to 7C, and FIG. 8) is received (Step S2).

Next, a judgment is made of whether or not the comment information 82 has been input (Step S3), and when the comment information 82 has not been input (Step S3: N), the routine moves to Step S5. On the other hand, when the comment information 82 has been input (Step S3: Y), the comment information 82 is registered in the comment information management table 112a, for each user identification code 115, associated with that function information 130 (Step S4), and then the routine moves to Step S5.

Then, a judgment is made of whether or not settings for the operation screen in the system settings mode are completed (Step S5), and when the settings for the operation screen have not been completed (Step S5: N), the routine moves to Step S2. On the other hand, when the settings for the operation screen have been completed (Step S5: Y), the routine moves to Step S6. In Step S6, settings/registration for the operation screen (here, registration to the address book of the recipient management table 105a of the management unit 105 or setting of a deletion size for border deletion) are performed, and the processing is ended.

(Function Execution Mode)

In this embodiment, the display control unit configured by the control unit 101, in the function execution mode, displays, among the comment information 82 that has been input by the input control unit, the comment information 82 of a user that has been authenticated, associated with the function information thereof.

This will be described, by way of example, for both a case where the comment information 82 is displayed when image data is sent by electronic mail in the function execution mode, and a case where the comment information 82 is displayed when executing various functions.

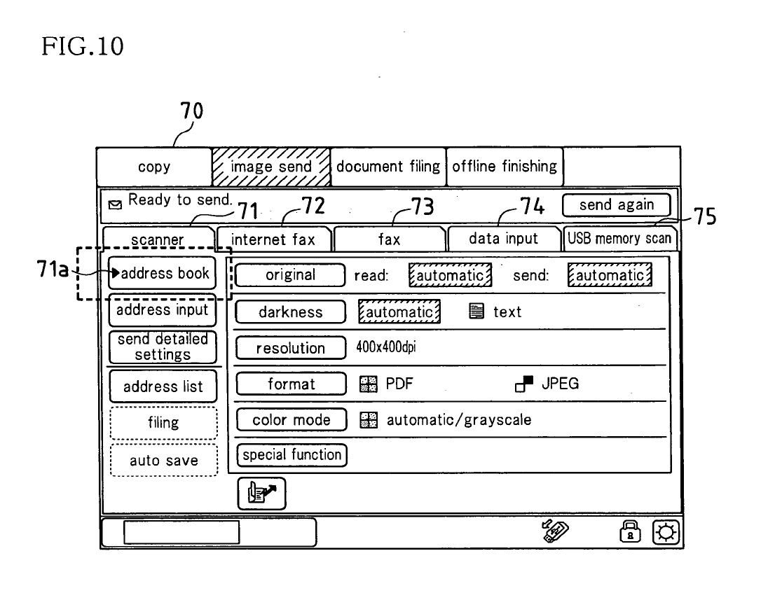

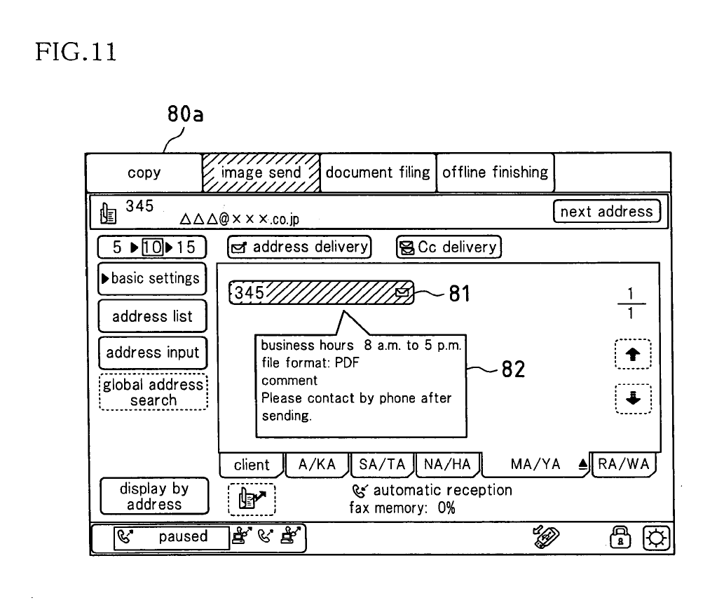

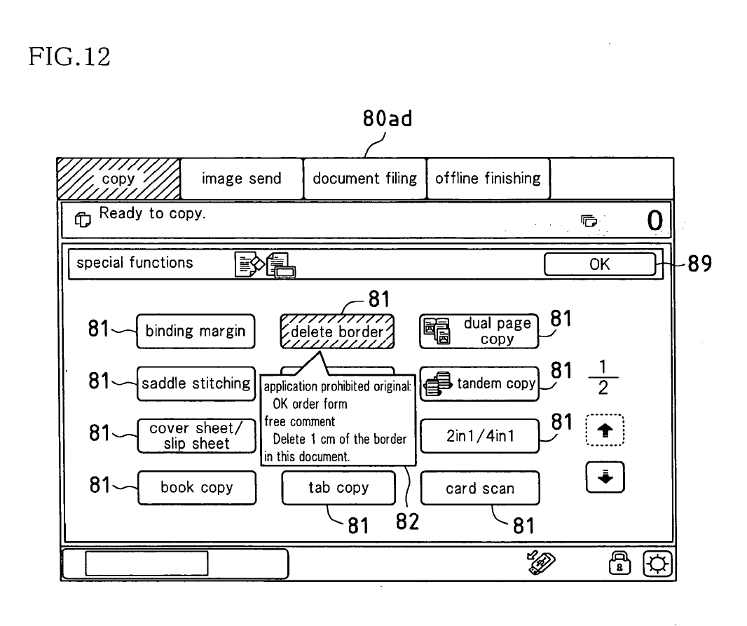

FIG. 10 is a schematic diagram that shows an example of a function operation screen displayed when the image send key 107f has been operated by pressing the image send key 107f in the initial screen shown in FIG. 5. FIG. 11 is a schematic diagram that shows an example of an operation screen displayed when a function selection key (here, an address book key) 71a has been operated by pressing the function selection key 71a in the function operation screen shown in FIG. 10, and shows a state in which the comment information 82 is displayed when sending image data by electronic mail. FIG. 12 is a schematic diagram that shows an example of an operation screen displayed when the special function key 108a has been operated by pressing the special function key 108a in the initial screen 10 shown in FIG. 5, and shows a state in which the comment information 82 is displayed when executing the border deletion function.

When the image send key 107f has been operated by pressing the image send key 107f in the operation panel 106 shown in FIG. 5, the control unit 101 displays a function operation screen 70 shown in FIG. 10 instead of the initial screen 10 as shown in the lower part of FIG. 5 in the display unit 108. Various send function keys 71 to 75 configured as software keys are disposed in the function operation screen (here, an image sending screen) 70.

The control unit 101, by these send function keys 71 to 75 being operated by pressing the send function keys 71 to 75, respectively, sends an image file read by scanning by electronic mail, sends an image file read by scanning by facsimile via the Internet, sends an image file read by scanning by facsimile via a public phone line, sends an image file read by scanning to the storage unit of a designated FTP (File Transfer Protocol) server, or sends an image file read by scanning to a USB (Universal Serial Bus) memory connected to the digital multifunction peripheral 100.

When the function selection key 71a has been operated by pressing the function selection key 71a in the function operation screen 70 shown in FIG. 10, the control unit 101 displays an operation screen (here, an address book screen) 80a shown in FIG. 11 instead of the function operation screen 70 in the display unit 108.

On the other hand, when the special function key 108a has been operated by pressing the special function key 108a in the operation panel 106 shown in FIG. 5, the control unit 101 displays an operation screen (here, a special function settings screen) 80ad shown in FIG. 12 instead of the initial screen 10 in the display unit 108.

Here, the display control unit configured by the control unit 101, as shown in FIGS. 11 and 12, displays, in the display unit 108, the comment information 82 for the function information displayed in the operation screen (here, the address book screen 80a or the special function settings screen 80ad) of the display unit 108 when selection/operation is performed for that function information (here, information for the image send function or a special function).

Specifically, the display control unit, in the function execution mode, is made capable of displaying a function execution key 81 (here, a software key that designates a recipient or a software key that sets border deletion) for executing various functions in the operation screen 80a or 80ad of the display unit 108 such that selection input is possible, and when the function execution key 81 displayed in the operation screen 80a or 80ad has been selected/operated, establishing an execution suspended state (for example, a selection display state in which the display state of the function execution key 81 is changed, such as a color change or reversed display, and execution is suspended), and displaying (here, displaying in a dialog balloon such that part of another function execution key 81 is concealed) the comment information 82 of the corresponding function (here, the send function to recipient ‘345’ or the frame deletion function) for that function execution key 81.

In this configuration, the comment information 82 for the function displayed in the operation screen 80a or 80ad of the display unit 108 can be displayed only when the user has performed selection/operation for that function. Furthermore, the comment information 82 can be displayed when the function execution key 81 displayed in the operation screen 80a or 80ad has been selected/operated, and thus, as the display space of the comment information 82, only the display space of the selected/operated comment information 82 is necessary, and to that extent, it is possible to save space for the display space of the operation screen 80a or 80ad, and also, the comment information 82 for the function to be executed (here, the image send function or the border deletion function) can be uniquely specified, and thus it is possible to reliably inform the user of the comment information 82 for the function to be executed.

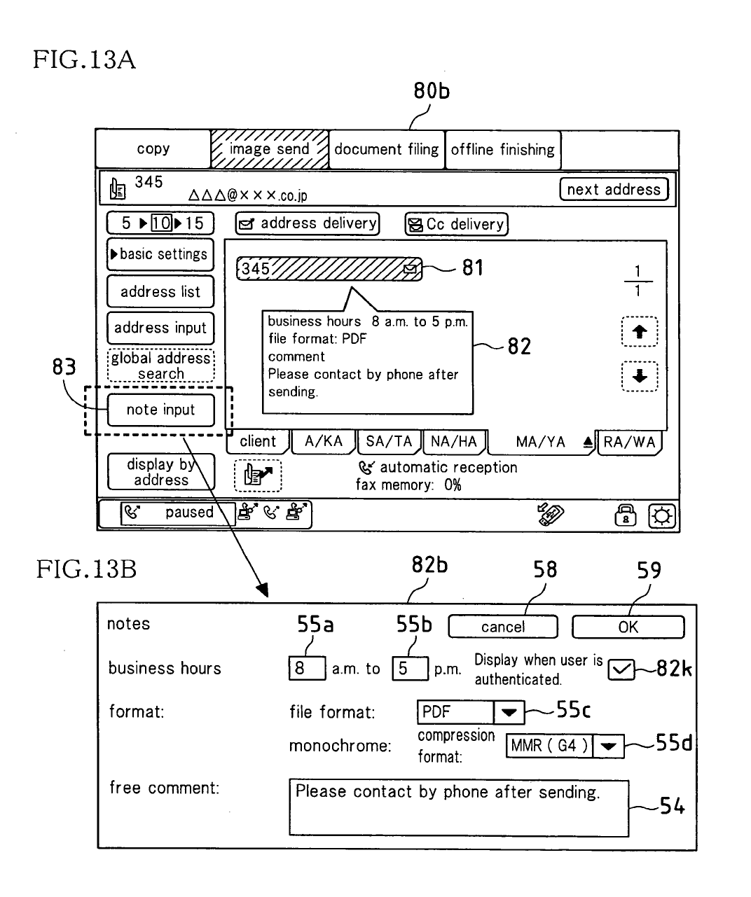

The send function is executed by operating the start key 107d of the operation panel 106 shown in FIG. 5 by pressing the start key 107d in the operation screen 80a of the image send function, and by operating an OK key 89 of the operation screen 80ad of the special function by operating the OK key 89 in the operation screen 80ad, the screen moves to the settings screen of the frame deletion function. This operation is the same in FIGS. 13 to 18 described below, and is therefore omitted from the below description.

The input control unit configured by the control unit 101 may also be made capable of inputting the comment information 82 to the operation screen 80a or 80ad in the function execution mode.

Specifically, when there has been a selection/operation for the function displayed in the operation screen 80a or 80ad of the display unit 108, the display control unit displays the comment information 82 for that function in the display unit 108, and afterward, when there has next been an operation for inputting that comment information 82, the input control unit executes an operation to input the comment information 82.

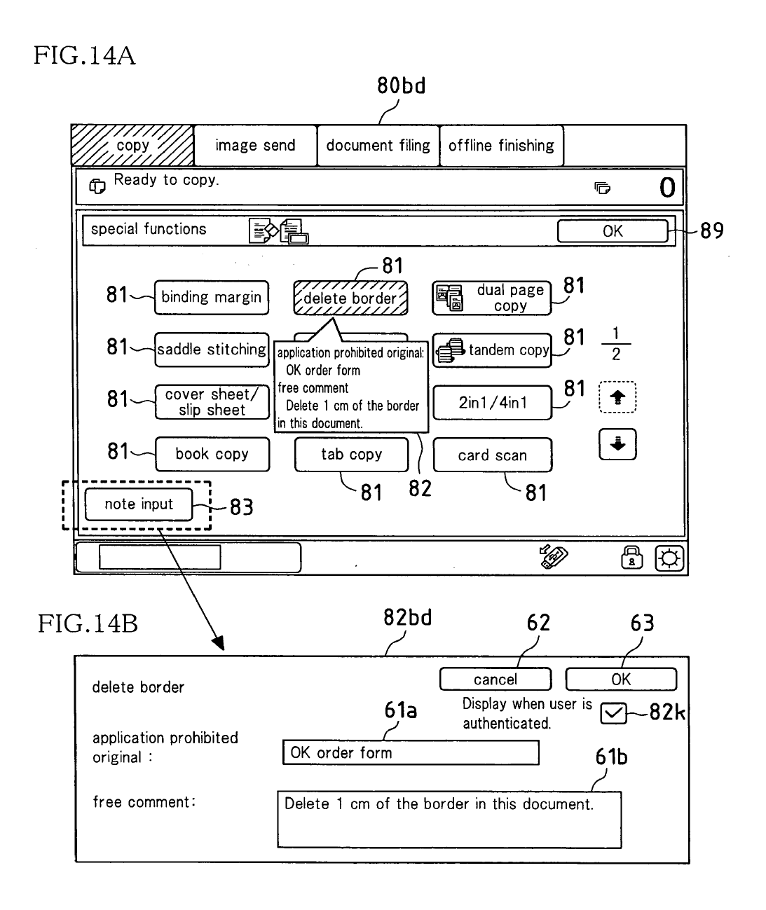

FIGS. 13A and 13B, and 14A and 14B, illustrate an example of an operation to input the comment information 82 in the function execution mode.

FIG. 13A is a schematic diagram that shows another example of an operation screen displayed when the function selection key 71a has been operated by pressing the function selection key 71a in the function operation screen shown in FIG. 10, and FIG. 13B is a schematic diagram that shows an example of a comment input screen 82b displayed when a comment information input key (here, a note input key that is a software key) 83 has been operated by pressing the comment information input key 83 in the operation screen shown in FIG. 13A.

FIG. 14A is a schematic diagram that shows another example of an operation screen displayed when the special function key 108a has been operated by pressing the special function key 108a in the initial screen 10 shown in FIG. 5, and FIG. 14B is a schematic diagram that shows an example of a comment input screen displayed when the comment information input key (here, a note input key that is a software key) 83 has been operated by pressing the comment information input key 83 in the operation screen shown in FIG. 14A.

As shown in FIGS. 13A and 14A, the display control unit is made capable of, in the function execution mode, displaying the function execution key 81 for executing various functions in the operation screen 80b or 80bd of the display unit 108 such that selection input is possible, and displaying the note input key 83 for executing the input control unit in the operation screen 80b or 80bd such that selection input is possible. The display control unit is made capable of establishing an execution suspended state (selection display state in which execution is suspended) when the function execution key 81 displayed in the operation screen 80b or 80bd has been selected/operated, and displaying the comment information 82 of the corresponding function (here, the send function to recipient ‘345’ and the border deletion function) for the function execution key 81. Also, when the display control unit establishes an execution suspended state when the function execution key 81 displayed in the operation screen 80b or 80bd has been selected/operated, and displays the comment information 82 of the corresponding function for that function execution key 81, and next the note input key 83 has been selected/operated, as shown in the comment input screen 82b or 82bd in FIGS. 13B and 14B, the input control unit can execute the operation to input the comment information 82 for the function that corresponds to that function execution key 81.

In this configuration, the comment information 82 for the function displayed in the operation screen 80b or 80bd of the display unit 108 can be displayed only when the user has performed selection/operation for that function. Furthermore, in the function execution mode, the user can add to/update the comment information 82 displayed when the function execution key 81 displayed in the operation screen 80b or 80bd has been selected/operated, in the comment input screen 82b or 82bd after confirming that comment information 82.

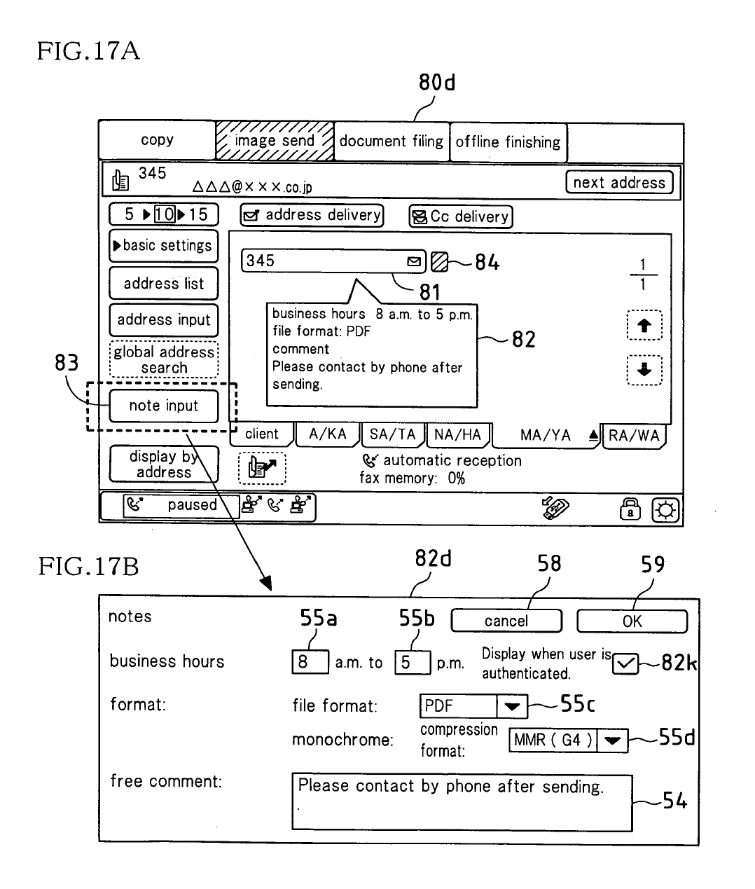

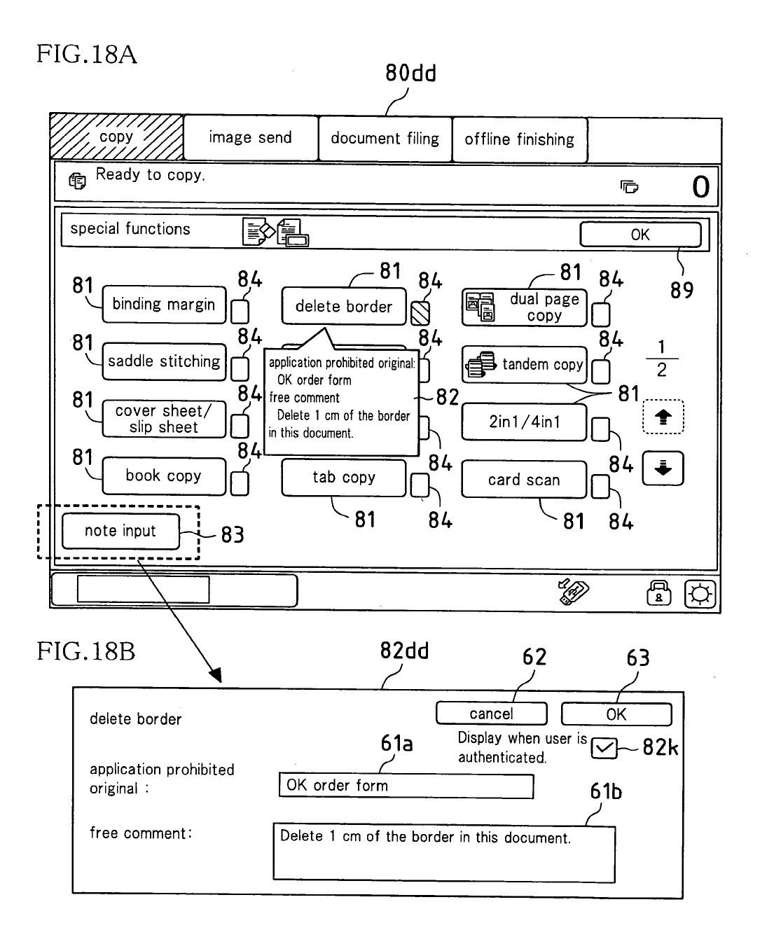

When the cancel key 58 or 62 respectively in the upper part of the comment input screen 82b or 82bd has been operated by pressing the cancel key 58 or 62, processing to return to the operation screen 80b or 80bd shown in FIGS. 13A and 14A is performed, and when the OK key 59 or 63 has been operated by pressing the OK key 59 or 63, the input content in the comment input screen 82b or 82bd is fixed, and processing to return to the operation screen 80b or 80bd shown in FIGS. 13A and 14A is performed. This operation is the same in FIGS. 17A and 17B, and 18A and 18B, described below, and is therefore omitted from the below description.

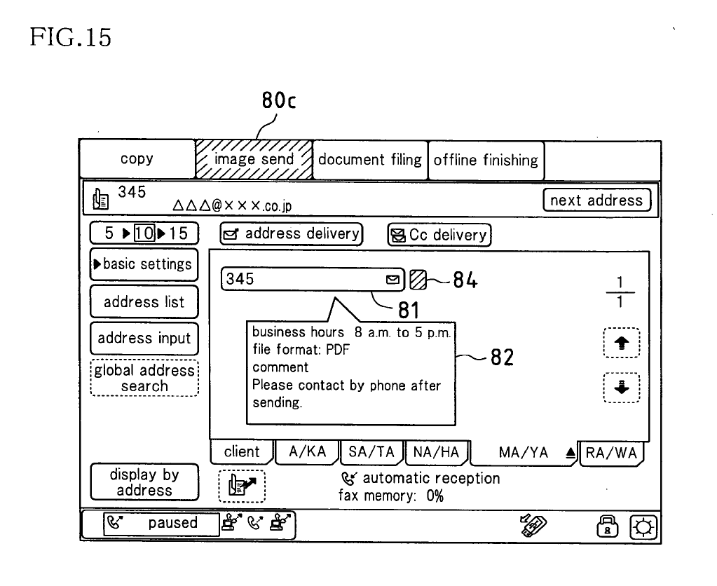

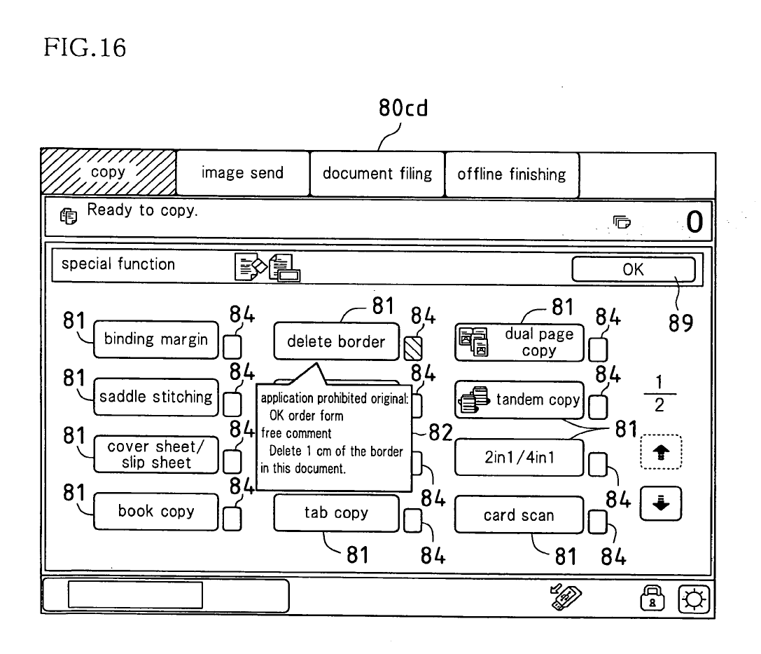

FIG. 15 is a schematic diagram that shows another example of an operation screen displayed when the function selection key 71a has been operated by pressing the function selection key 71a in the function operation screen shown in FIG. 10. FIG. 16 is a schematic diagram that shows another example of an operation screen displayed when the special function key 108a has been operated by pressing the special function key 108a in the initial screen shown in FIG. 5.

The display control unit configured by the control unit 101, as shown in FIGS. 15 and 16, may display, in the display unit 108, the comment information 82 for the function information displayed in the operation screen (here, the address book screen 80c or the special function settings screen 80cd) of the display unit 108 when an operation for outputting that comment information 82 (here, information for the image send function or a special function) has been performed.

Specifically, the display control unit, in the function execution mode, is made capable of displaying a function execution key 81 (here, a software key that designates a recipient and a software key that sets border deletion) for executing various functions in the operation screen 80c or 80cd of the display unit 108 such that selection input is possible, and displaying a comment information display icon 84 for displaying that comment information 82 in the operation screen 80c or 80cd, associated with that function execution key 81 such that selection input is possible. The comment information display icon 84 can be displayed only when the comment information 82 has been input (when the comment information 82 exists). Also, the display control unit, when the comment information display icon 84 displayed in the operation screen 80c or 80cd has been selected/operated, is made capable of displaying the comment information 82 of the corresponding function (here, the send function to recipient ‘345’ or the frame deletion function) for the function execution key 81 that corresponds to that comment information display icon 84.

With this configuration, the comment information display icon 84 is displayed only when the comment information 82 has been input, so it is possible for the user to easily identify whether or not the comment information 82 exists. Also, it is possible to display the comment information 82 for the function information displayed in the operation screen 80c or 80cd of the display unit 108 only when the user wants to confirm that information. Furthermore, the comment information 82 can be displayed when the comment information display icon 84 displayed in the operation screen 80c or 80cd has been selected/operated, and thus, as the display space of the comment information 82, only the display space of the selected/operated comment information 82 is necessary, and to that extent, it is possible to save space for the display space of the operation screen 80a or 80ad, and also, the comment information 82 for the function to be executed (here, the image send function or the border deletion function) can be uniquely specified, and thus it is possible to reliably inform the user of the comment information 82 for the function to be executed.

The input control unit configured by the control unit 101 may also be made capable of inputting the comment information 82 to the operation screen 80c or 80cd in this function execution mode.

Specifically, when there has been an operation to output the comment information 82 for the function information displayed in the operation screen 80c or 80cd of the display unit 108, the display control unit displays that comment information 82 in the display unit 108, and afterward, when there has next been an operation for inputting that comment information 82, the input control unit executes an operation to input the comment information 82.

FIGS. 17A and 17B, and 18A and 18B, illustrate an example of an operation to input the comment information 82 in the function execution mode.

FIG. 17A is a schematic diagram that shows still another example of an operation screen displayed when the function selection key 71a has been operated by pressing the function selection key 71a in the function operation screen shown in FIG. 10, and FIG. 17B is a schematic diagram that shows an example of a comment input screen displayed when a comment information input key (here, a note input key) 83 has been operated by pressing the comment information input key 83 in the operation screen shown in FIG. 17A.

FIG. 18A is a schematic diagram that shows still another example of an operation screen displayed when the special function key 108a has been operated by pressing the special function key 108a in the initial screen shown in FIG. 5, and FIG. 18B is a schematic diagram that shows an example of a comment input screen displayed when a comment information input key (here, a note input key) 83 has been operated by pressing the comment information input key 83 in the operation screen shown in FIG. 18A.

As shown in FIGS. 17A and 18A, the display control unit is made capable of, in the function execution mode, displaying a function execution key 81 for executing various functions in the operation screen 80d or 80dd of the display unit 108 such that selection input is possible, and displaying a comment information display icon 84 for displaying that comment information 82 in the operation screen 80d or 80dd, associated with that function execution key 81, such that selection input is possible, and also, displaying the note input key 83 for executing the input control unit in the operation screen 80d or 80dd such that selection input is possible. Here, it is possible for the comment information display icon 84 to be displayed only when the comment information 82 has been input (when the comment information 82 exists).

The display control unit, when a comment information display icon 84 displayed in the operation screen 80d or 80dd has been selected/operated, is made capable of displaying the comment information 82 of the corresponding function (here, a send function to recipient ‘345’ or a border deletion function) for the function execution key 81 that corresponds to that comment information display icon 84. Also, the display control unit, when a comment information display icon 84 displayed in the operation screen 80d or 80dd has been selected/operated, is made capable of displaying the comment information 82 of the corresponding function for the function execution key 81 that corresponds to that comment information display icon 84, and when next the note input key 83 has been selected/operated, as shown in the comment input screen 82d or 82dd of FIGS. 17B and 18B, the input control unit can execute an operation to input the comment information 82 for the function that corresponds to that function execution key 81.

With this configuration, the comment information display icon 84 is displayed only when the comment information 82 has been input, so it is possible for the user to easily identify whether or not the comment information 82 exists. Also, it is possible to display the comment information for the function information displayed in the operation screen 80d or 80dd of the display unit 108 only when the user wants to confirm that information. Furthermore, in the function execution mode, the user can add to/update the comment information 82 displayed when the comment information display icon 84 displayed in the operation screen 80d or 80dd has been selected/operated, in the comment input screen 82d or 82dd after confirming that comment information 82.

The display control unit also may, in the function execution mode, display the function execution keys 81 for executing various functions in an operation screen of the display unit 108 such that selection/input is possible, and may display all comment information 82 (for example, displaying all comment information 82 in a list) corresponding to the function execution keys 81.

In this case, the user can at once view all of the comment information for each function execution key displayed in an operation screen of the display unit 108.

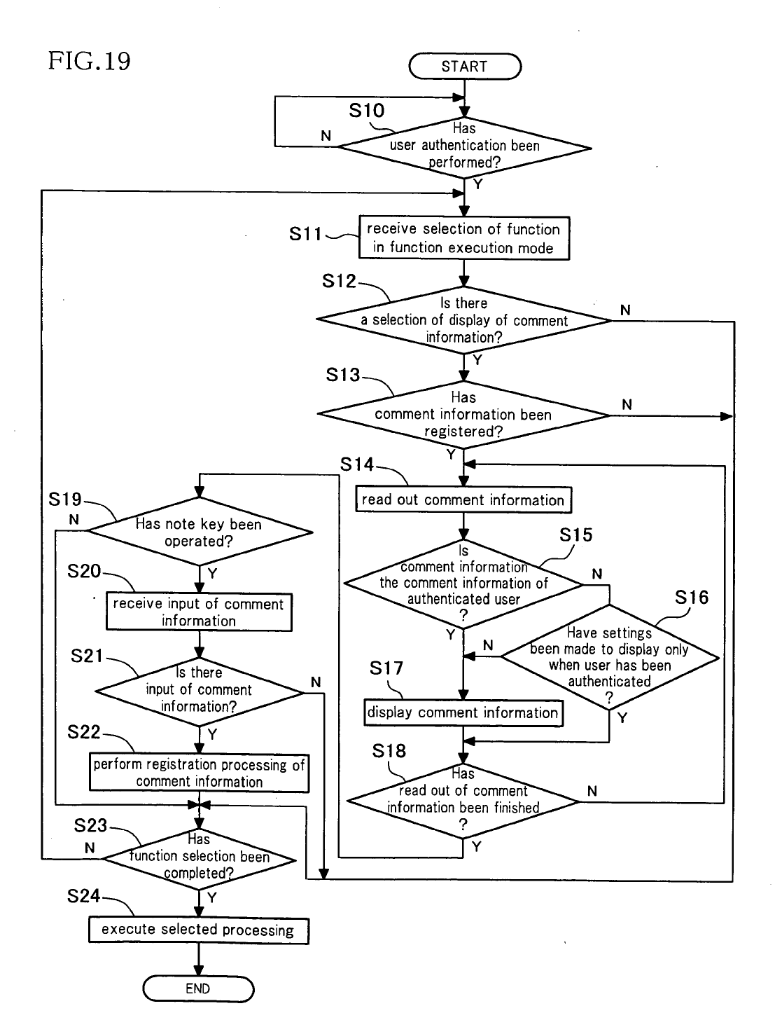

Next is a description of an operation flow of display and input of the comment information 82 for function information displayed in an operation screen in the function execution mode, with reference to FIG. 19.

FIG. 19 is a flowchart that shows the flow of processing to display and input the comment information 82 for function information displayed in an operation screen in the function execution mode.

In the processing shown in FIG. 19, first, user authentication is performed in a login screen (Step S10). Specifically, input of a user name (user identification code 115) and a password in the login screen is awaited (Step S10: N), user authentication is performed by the user name and password being input (Step S10: Y), and then the routine moves to Step S11, where selection of a function (for example, a send function using an address book or various print functions) in the function execution mode is received (Step S11).

Next, when display of the comment information 82 has not been selected (Step S12: N), the routine moves to Step S23, and on the other hand, when display of the comment information 82 has been selected (Step S12: y), a judgment is made of whether or not the comment information 82 has been registered (Step S13). When the comment information 82 has not been registered (Step S13: N), the routine moves to Step S23, and on the other hand, when the comment information 82 has been registered (Step S13: y), the comment information 82 is read out from the comment information management table 112a (Step S14).

A judgment is made of whether or not the comment information 82 that has been read out from the comment information management table 112a is comment information of the authenticated user (user identification code 115)(Step S15), and when the read comment information is comment information of the authenticated user (user identification code 115), the routine moves to Step S17. On the other hand, when the read comment information is not comment information of the authenticated user (user identification code 115), a judgment is made of whether the output switching identification information 82a has been set so as to display comment information only when a user has been authenticated (whether the output switching identification information 82a is set to an authenticated output code)(Step S16). When the output switching identification information 82a is an authenticated output code (here, ‘1’), the routine moves to Step S18, and on the other hand, when the output switching identification information 82a is not an authenticated output code (here, ‘1’), i.e., when the output switching identification information 82a is an all user output code (here, ‘0’), the routine moves to Step S17.

next, in Step S17, the comment information 82 is displayed, and in Step S18, a judgment is made of whether or not reading of the comment information 82 from the comment information management table 112a is finished. When reading of the comment information 82 is not finished (Step S18: N), the routine moves to Step S14, and on the other hand, when reading of the comment information 82 is finished, the routine moves to Step S19.

Then, a judgment is made of whether or not the note input key 83 has been operated (Step S19). When the note input key 83 has not been operated (Step S19: N), the routine moves to Step S23, and on the other hand, when the note input key 83 has been operated (Step S19: Y), input of the comment information 82 is received (Step S20).

Next, a judgment is made of whether or not the comment information 82 has been input (Step S21). When the comment information 82 has not been input (Step S21: N), the routine moves to Step S23, and on the other hand, when the comment information 82 has been input (Step S21: Y), the comment information 82 is registered in the comment information management table 112a, for each user identification code 115, associated with that function information 130 (Step S22), and then the routine moves to Step S23.

Then, a judgment is made of whether or not selection of the function in the function execution mode is completed (Step S23). When selection of the function has not been completed (Step S23: N), the routine moves to Step S11, and on the other hand, when selection of the function has been completed (Step S23: Y), the routine moves to Step S24. In Step S24, the selected function is executed (here, sending to recipient ‘345’ using an address book or setting of border deletion), and then processing is ended.

Incidentally, here, the comment information 82 is displayed so as to conceal part of another function execution key 81, and in this case, the problem occurs that the comment information 82 becomes an obstruction and the other function execution key 81 cannot be operated. To address this problem, as already described above in connection with the system settings mode, the display control unit is configured to display the comment information 82 for a predetermined fixed time period from the start of display. By doing so, even if part of another function execution key 81 is concealed by the comment information 82, that other function execution key 81 can be selected after passage of a predetermined time period. Also, the comment information 82 may be displayed in an open space other than the display location of the function execution key.

Also, the input control unit is made capable of inputting an output condition when outputting the comment information 82 with the output control unit. Here, this output condition, as shown in FIG. 7C, involves selection of a comment display time and a comment display condition, i.e., selection of whether to display the comment information 82 with the function execution key 81 as shown in FIGS. 11 to 14 (when selecting the function execution key), or to display the comment information 82 with the comment information display icon 84 as shown in FIGS. 15 to 18 (when selecting the comment display key), or alternatively, selection of whether or not to use the output switching identification information 82a. Note that when not using the output switching identification information 82a, Step 16 in the flowchart in FIG. 19 described above can be omitted.

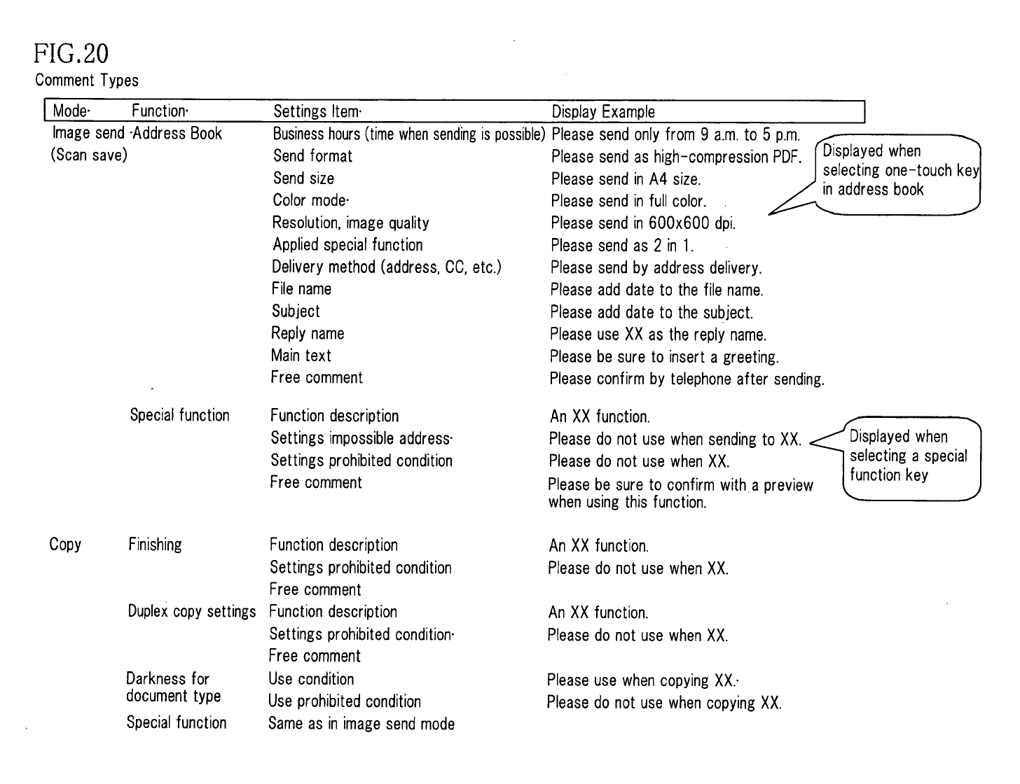

In the above description, the operation screen of the image send function and the operation screen of the border deletion function were given as examples, but it goes without saying that the same operations can also be performed in another operation screen. FIG. 20 shows a list of comment information that is input in the operation screens of various functions (examples of comments for setting items of various functions).

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. (canceled)

2: An image forming apparatus, comprising:
a display unit having an operation screen;
an input unit configured to input comment information;
a storage unit configured to store the comment information input by the input unit; and
a display control unit configured to display, on the display unit, the comment information stored in the storage unit.

3: The image forming apparatus according to claim 2,
wherein the display control unit is configured to display the comment information associated with operation keys displayed on the operation screen.

4: The image forming apparatus according to claim 2,
wherein the display control unit is configured to display the comment information when operation keys displayed on the operation screen are selected and operated.

5: The image forming apparatus according to claim 2,
wherein the display control unit is configured to display the comment information on the operation screen for only a predetermined fixed time.

6: An image forming apparatus, comprising:
a display unit having an operation screen;
an image forming unit configured to form an image on paper under conditions input on the operation screen;
an input unit configured to input comment information;
a storage unit configured to store the comment information input by the input unit; and
a display control unit configured to display, on the display unit, the comment information stored in the storage unit.

7: The image forming apparatus according to claim 6,
wherein the display control unit is configured to display the comment information associated with operation keys displayed on the operation screen.

8: The image forming apparatus according to claim 6,
wherein the display control unit is configured to display the comment information when operation keys displayed on the operation screen are selected and operated.

9: The image forming apparatus according to claim 6,
wherein the display control unit is configured to display the comment information on the operation screen for only a predetermined fixed time.

10: The image forming apparatus according to claim 6, further comprising an image send function,
wherein the image forming apparatus includes a sending unit configured to send an image to paper under conditions input on the operation screen.

11: An image forming apparatus, comprising:
a display unit having an operation screen;
a user authentication unit configured to perform user authentication;
an input unit configured to input comment information;
a storage unit configured to store the comment information input by the input unit; and
a display control unit configured to display, on the display unit, the comment information associated with a user authenticated by the user authentication unit.

12: The image forming apparatus according to claim 11,
wherein the display control unit is configured to display the comment information associated with operation keys displayed on the operation screen.

13: The image forming apparatus according to claim 11,
wherein the display control unit is configured to display the comment information when operation keys displayed on the operation screen are selected and operated.

14: The image forming apparatus according to claim 11,
wherein the display control unit is configured to display the comment information on the operation screen for only a predetermined fixed time.

15: A method for controlling an image forming apparatus, comprising the steps of:
displaying an operation screen on a display unit;
inputting comment information by an input unit;
storing, in a storage unit, the comment information input by the input unit; and
displaying, on the display unit by a display control unit, the comment information stored in the storage unit.

16: The method for controlling an image forming apparatus according to claim 15, wherein the display control unit displays the comment information associated with operation keys displayed on the operation screen.

17: The method for controlling an image forming apparatus according to claim 15, wherein the display control unit displays the comment information when operation keys displayed on the operation screen are selected and operated.

18: The method for controlling an image forming apparatus according to claim 15, wherein the display control unit displays the comment information on the operation screen for only a predetermined fixed time.
